(19) United States
(12) Patent Application Publication
(10) Pub. No.: US 2026/0073169 A1
(43) Pub. Date: Mar. 12, 2026

(54) Two-Dimensional Code and Method Thereof

(71) Applicant: TELEFONAKTIEBOLAGET LM ERICSSON (PUBL), Stockholm (SE)

(72) Inventors: Alexandros Palaios, Herzogenrath (DE); Daniela Ionita, Herzogenrath (DE); Halbe Tiemen Hageman, Aachen (DE); Tobias Engelbert, Wuerselen (DE)

(21) Appl. No.: 19/109,540

(22) PCT Filed: Sep. 7, 2023
(86) PCT No.: PCT/SE2023/050885

§ 371 Date: Mar. 6, 2025

(30) Foreign Application Priority Data
Sep. 12, 2022 (GR) 20220100741

(51) Int. Cl. G06K 7/14; G06K 19/06

(52) U.S. Cl. CPC G06K 7/14; G06K 19/06037

(57) ABSTRACT

The present disclosure relates to a two-dimensional code (100) comprising: a plurality of positions (110) arranged along a plurality of concentric circles (120), the plurality of concentric circles having a common center (130) and being arranged substantially on a two-dimensional plane, each of said positions (110) indicating presence of a symbol or absence of a symbol, each presence or absence of a symbol at each position being optically readable and representing a data value set to each of the plurality of positions (110); and a first reference pattern portion (140) including a set of the plurality of positions indicating at least the common center (130), wherein the first reference pattern portion (140) comprises all positions along the inner most circle of the plurality of concentric circles (120), wherein all positions along the inner most circle indicate presence of a symbol.

### TECHNICAL FIELD

The present disclosure relates to a two-dimensional code. The present disclosure further relates to methods, devices, and a computer program product.

### BACKGROUND

Visual codes are frequently used today for accessing information. Well known marking codes today are the BAR code and the QR code. They generally perform well in many circumstances. The bar code has a low code density in general 10-14 digits. The QR code has instead a very high density up to hundreds of characters.

The bar code (or multiple bar codes) can easily be scanned with laser illumination. The QR code performs well in camera/picture-based scanning.

A drawback with the QR code is that only one QR code per image can be used. Further an image used to read the code, preferably should be captured close to the QR code so that the QR code fills most of the field of view of the image. In other words, the requirement for the number of pixels representing elements in the code is relatively high.

A further drawback is that relative flat surface is required to successfully read the code and can easily become unreadable if a label that a code is printed on, is wrinkled or otherwise deformed. In other words, the codes are not suitable for rugged surfaces. U.S. Pat. No. 5,554,841A discloses a graphical symbol encoding a numerical value that may be read when placed on a non-planar surface.

Thus, there is a need for an improved code, method for printing the code and a method for decoding the code.

### SUMMARY OF THE INVENTION

The above-described drawbacks are overcome by the subject matter described herein. Further advantageous implementation forms of the invention are described herein.

According to a first aspect of the invention the object of the invention is achieved by a two-dimensional code comprising a plurality of positions arranged along a plurality of concentric circles, the plurality of concentric circles having a common center and being arranged substantially on a two-dimensional plane, each of said positions indicating presence of a symbol or absence of a symbol, each presence or absence of a symbol at each position being optically readable and representing a data value set to each of the plurality of positions; and
a first reference pattern portion including a set of the plurality of positions indicating at least the common center, wherein the first reference pattern portion comprises all positions along the inner most circle of the plurality of concentric circles, wherein all positions along the inner most circle indicate presence of a symbol.

In one embodiment of the first aspect, the two-dimensional code further comprises a second reference pattern portion indicative of a rotational reference of the plurality of positions around the common center.

In one embodiment of the first aspect, the indication of the rotational reference is indicated by one or more reference positions arranged on at least one circle of the plurality of concentric circles.

In one embodiment of the first aspect, the second reference pattern portion comprises a position on two or more of the concentric circles arranged along a line intersecting the common center.

In one embodiment of the first aspect, wherein the second reference pattern portion comprises a predetermined sequence of presence or absence of a symbols.

In one embodiment of the first aspect, the symbol is a filled circle.

In one embodiment of the first aspect, the inner most circle of the plurality of concentric circles generates a blank space in the center of the plurality of concentric circles, the blank space being larger than the size of a symbol.

An advantage of the first aspect is at least that increased code density is achieved and/or that the code performs well on smooth as well as rough surfaces. This is important in responsible forestry together with the use of communication networks such as the fifth generation 5G ecosystem. A further advantage is that lower administrative and inspection burden for sustainable forestry is enabled. A further advantage is that increased traceability of “FSC” marked wood products is achieved. A further advantage is that support for governmental forestry programs is enabled. A further advantage is that the disclosure makes it difficult to insert illegal wood in the production cycles. A further advantage is that the code is suitable for rugged surfaces. A further advantage is that the code is tolerant to physical wear.

According to a second aspect of the invention the object of the invention is achieved by a method to decode one or more two-dimensional codes according to the first aspect. The method comprises obtaining an image depicting a scene comprising the one or more two-dimensional code, and for each of the two-dimensional codes, identifying a common center of a plurality of concentric circles, identify a rotation of the two-dimensional code, identify a presence of a symbol or an absence of a symbol for each of a plurality of positions of the two-dimensional code using the identified respective common center and identified rotation, decoding two-dimensional code by mapping the presence of a symbol or an absence of a symbol for each of the plurality of positions to a data value, the data value set to each of the plurality of positions.

In one embodiment of the second aspect, the symbol is configured with a shape of a dot, wherein identifying a common center comprising identifying a circular shaped area, wherein the circular shaped area is configured with a diameter of 3 times a diameter of the dot shape.

In one embodiment of the second aspect, decoding the two-dimensional code further comprises applying a mask to the obtained image.

In one embodiment of the second aspect, the method further comprises generating the mask by detecting a radial ring line using the symbols, wherein the radial ring line is formed by connecting detected centers of the symbols.

In one embodiment of the second aspect, the method further comprises generating the mask by forming a circular area defined by an inner and an outer radius, wherein the mask is generated as a radial segment on the radius of the circular area, wherein the mask is applied to the obtained image by rotating the radial segment around the common center.

In one embodiment of the second aspect, the method further comprises generating the mask by generating one detection area for each of the plurality of concentric circles, wherein the detection areas are positioned on each of the concentric circles and arranged along a line intersecting the common center, wherein the mask is applied to the obtained image by rotating the radial segment around the common center.

In one embodiment of the second aspect, the method further comprises generating an enhanced image by performing image processing on the obtained image.

In one embodiment of the second aspect, the image processing comprises contrast/brightness adjustment.

In one embodiment of the second aspect, the image processing comprises symbol size correction.

In one embodiment of the second aspect, the image processing comprises angle and/or projection correction.

In one embodiment of the second aspect, identifying the common center comprises selecting at least two exclusive pairs, each pair comprising two positions where presence of a symbol has been identified and are on the same concentric circle, identifying the common center of the plurality of concentric circles by detecting a position where a respective perpendicular bisector line of the at least two pairs intersect.

In one embodiment of the second aspect, a subset of the plurality of positions are indicative of a rotational reference of the plurality of positions around the common center, wherein identify a rotation comprises detecting the position of the rotational reference of the one or more two-dimensional codes.

In one embodiment of the second aspect, the rotational reference is one or more reference positions arranged on at least one circle of the plurality of concentric circles.

In one embodiment of the second aspect, the one or more reference positions are arranged on at least two of the plurality of concentric circles along a line intersecting the common center.

In one embodiment of the second aspect, the rotational reference is one or more reference positions arranged on at least one circle of the plurality of concentric circles, wherein the one or more reference positions are indicative of a predefined sequence of presence of a symbol or an absence of a symbol.

According to a third aspect of the invention the object of the invention is achieved by a device for performing a method comprising processing circuitry; and a memory, said memory containing instructions executable by said processor, whereby said device is operative to perform the method according to the second aspect.

According to a fourth aspect of the invention the object of the invention is achieved by method to generate one or more two-dimensional codes according to the first aspect. The two-dimensional code comprising a plurality of positions, the symbols being arranged along a plurality of concentric circles, the concentric circles being arranged substantially on a two-dimensional plane. The method comprises: receiving payload data, mapping the payload data to a presence of a symbol or an absence of a symbol for each of the plurality of positions of the one or more two-dimensional codes using the identified common center and identified rotation, generating the one or more two-dimensional codes by printing the symbols mapped as presence of a symbol on a surface.

According to a fifth aspect of the invention the object of the invention is achieved by device for generating one or more two-dimensional codes according to the first aspect. The device comprising processing circuitry; and a memory, said memory containing instructions executable by said processor, whereby said device is operative to perform the method according to the fourth aspect.

According to a sixth aspect of the invention the object of the invention is achieved by a computer program comprising computer-executable instructions for causing a device, when the computer-executable instructions are executed on processing circuitry comprised in the device, to perform the method according to the second or fourth aspects.

According to a seventh aspect of the invention the object of the invention is achieved by a computer program product comprising a computer-readable storage medium, the computer-readable storage medium having the computer program according to the sixth aspect embodied therein.

The advantage of the second to seventh aspect is at least the same as for the first aspect.

The scope of the invention is defined by the claims, which are incorporated into this section by reference. Reference will be made to the appended sheets of drawings that will first be described briefly

### BRIEF DESCRIPTION OF THE DRAWINGS

Objects and aspects of the present disclosure will become apparent from the following description with reference to the figures described below. It should be appreciated that like reference numerals are used to identify like elements illustrated in one or more of the figures.

FIG. 1A illustrates concentric circles and a common center of a two-dimensional code according to one or more embodiments of the present disclosure.

FIG. 1B illustrates a two-dimensional code according to one or more embodiments of the present disclosure.

FIG. 2 illustrates identification of a common center according to one or more embodiments of the present disclosure.

FIG. 3A illustrates identification of a rotational reference according to one or more embodiments of the present disclosure.

FIG. 3B illustrates rotational reference and payload data according to one or more embodiments of the present disclosure.

FIG. 3C illustrates extension symbols of the rotational reference according to one or more embodiments of the present disclosure.

FIG. 4 illustrates identification of a rotational reference according to one or more embodiments of the present disclosure.

FIG. 5A illustrates identification of a rotational reference according to one or more embodiments of the present disclosure.

FIG. 5B illustrates identification of a rotational reference according to one or more embodiments of the present disclosure.

FIG. 6A shows angles and overlapping according to one or more embodiments of the present disclosure.

FIG. 6B shows relative angles and overlapping probability according to one or more embodiments of the present disclosure.

FIG. 7 illustrates extracted data according to one or more embodiments of the present disclosure.

FIG. 8 shows an example of code characteristics according to one or more embodiments of the present disclosure.

FIG. 9 shows a flowchart of a method according to one or more embodiments of the present disclosure.

FIG. 9A shows a flowchart of a method according to one or more embodiments of the present disclosure.

FIG. 9B shows a flowchart of a method according to one or more embodiments of the present disclosure.

FIG. 9C shows a flowchart of a method according to one or more embodiments of the present disclosure.

FIG. 10A illustrates detection areas for a first embodiment according to one or more embodiments of the present disclosure.

FIG. 10B shows an example of identifying and decoding according to one or more embodiments of the present disclosure.

FIG. 11A illustrates detection areas for a second embodiment according to one or more embodiments of the present disclosure.

FIG. 11B shows an example of identifying and decoding according to one or more embodiments of the present disclosure.

FIG. 12 illustrates detection areas for a third embodiment according to one or more embodiments of the present disclosure.

FIG. 13A illustrates details of the third embodiment according to one or more embodiments of the present disclosure.

FIG. 13B illustrates details of the third embodiment according to one or more embodiments of the present disclosure.

FIG. 14 shows a flowchart of a method according to one or more embodiments of the present disclosure.

FIG. 15 shows details of a device configured to decode or to print one or more two-dimensional codes according to one or more embodiments of the present disclosure.

FIG. 16 illustrates a use case embodiment of a method according to one or more embodiments in the present disclosure.

### DETAILED DESCRIPTION

The present disclosure relates to a two-dimensional code. The present disclosure further relates to methods of printing and decoding the two-dimensional code.

The two-dimensional code is based on information represented by symbols arranged on a plurality of concentric circles aligned with a common center. In particular, the two-dimensional code comprises a plurality of positions arranged along the plurality of concentric circles. The plurality of concentric circles has a common center and is arranged substantially on a two-dimensional plane. In particular, the two-dimensional code enables an increased code density. In some embodiments the two-dimensional code is suitable to be printed on a rugged surface. An example of a two-dimensional code would be a circular dot code.

Each of the positions indicates either presence of a symbol or absence of a symbol. Each of the presence or absence of the symbol at each position is optically readable and represents a data value set associated to each of the plurality of positions. In one example, a presence represents a digital 1 value, and an absence represents a digital 0 value.

The two-dimensional code comprises at least one reference pattern portion and a rotational reference.

A first reference pattern portion includes a set of positions selected from the plurality of positions and indicates at least the common center of the plurality of concentric circles. The first reference pattern portion comprises all positions along the inner most circle of the plurality of concentric circles. All the positions along the inner most circle of the plurality of concentric circles encircles an empty space/area which is enclosing the common center. Further, all positions along the inner most circle indicate presence of a symbol. In one example, the symbol is a dot, and all the dots are present on the inner circle.

Optionally, the two-dimensional code comprises a second reference pattern portion indicative of a rotational reference of the plurality of positions around the common center. This allows for a rotation of the code to be identified before decoding the code.

In one use case embodiment, the two-dimensional code is used for identification of sustainable wood. When a tree is sawed, the two-dimensional code is printed on the surface of the sawed side. A printing device performs a method to print the two-dimensional code on the surface of the sawed side. The printing device connects via a Radio Access Network (RAN) to a core network, e.g., a fifth generation (5G) core control network. The printing devices sends data including International Mobile Equipment Identity, IMEI, and Location Information for authentication, authorization and account. Authentication (to identify), Authorization (to give permission) and Accounting, AAA is performed by the core network. The printing device connects to an Application Function (AF). The AF creates a two-dimensional code, e.g., a circular dot code (two-dimensional code) and stores the two-dimensional code with IMEI, Date, Time and Location Information in a database (DB) and sends the two-dimensional code back to the printing device. The printing device prints the two-dimensional code on the surface and sends back an Indication when it is done.

Whenever a device, or scanning device, suitable for scanning the two-dimensional code is used to check the two-dimensional code, e.g., a Scan/Photo entity, either comprised in the device or external and communicatively coupled to the device, the device connects via RAN to the 5G core network and sends data including IMEI and Location Information to the AF.

In one example, the device or scanning device is a user equipment, UE, which connects via RAN to an Application Function (AF) comprised in the 5G core control network and sends data including IMEI and Location Information to the Application Function (AF).

In other words, the device can obtain an image depicting a scene comprising the one or more two-dimensional code either via an integrated scan/photo entity or camera or obtaining the image depicting a scene comprising the one or more two-dimensional code by receiving the image from an external scan/photo entity or camera.

Authentication (to identify), Authorization (to give permission) and Accounting, AAA is performed in the core network and connection to an AF is established for the device. The device sends the picture via User Plane to the AF where decoding is performed. An acknowledgement is sent back to the device which may comprise other information present in the database (DB). The new Location Information, Date, Time and IMEI is stored in the DB.

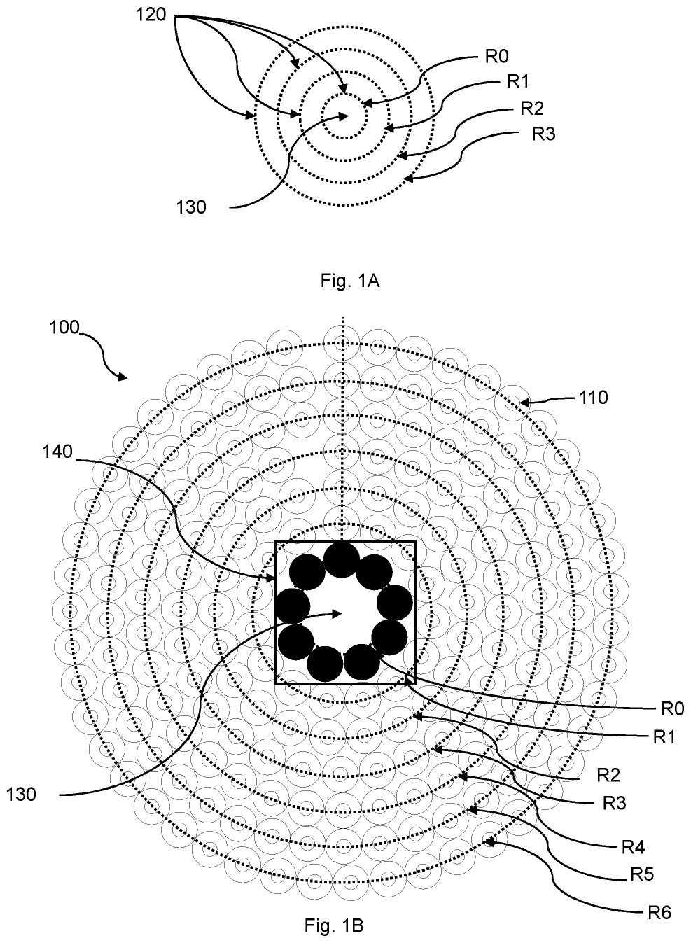

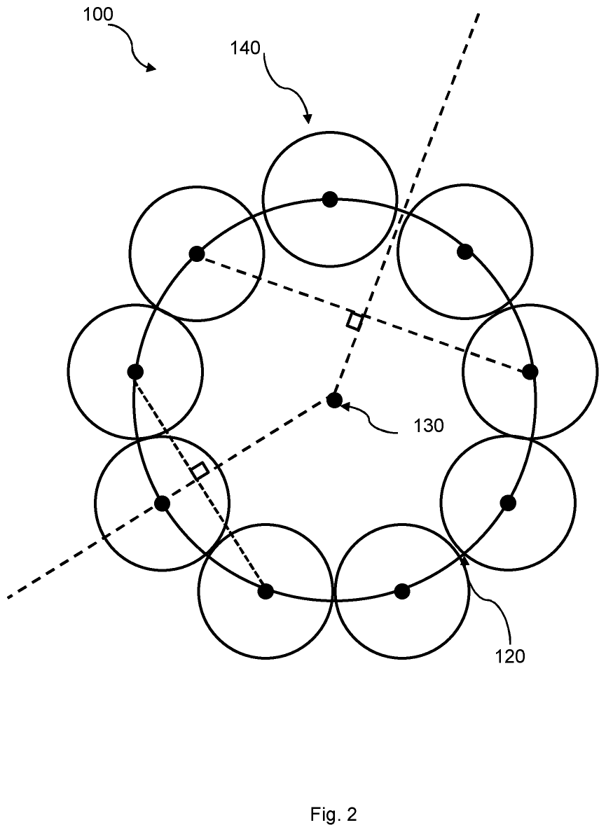

Assuming this example with a tree-cut surface for identifying sustainable wood. The following calculation illustrates an example of a two-dimensional code, e.g., 4-circle circular dot code, where the second most inner circle to the outer most circle R1-R3 represent numerical values or payload data and the inner most circle R0 represents a reference pattern portion representing a common center 130. In other words, circles R1-R3 are the 3 circles that represents the numerical values. Circles of the code are further described in relation to FIG. 1A.

The total surface of earth is about 510 million square kilometers, km2. Of that, about 149 km2 constitute land mass and less than 50% of that is available area for forests.

The two-dimensional code then encodes the following information:

1. In a first circle, circle R1, there is encoded 14 bits of e.g., a country or region code. Circles of the code are further described in relation to FIG. 1A. This would for example, be 18310 km2 per bit. As an example, the surface for the whole of Germany is approximately 357 580 km2, so several regions in Germany are possible (in this example, up to 19 regions)

2. In a second circle, circle R2, there is encoded the area indication. Circles of the code are further described in relation to FIG. 1A. This example uses 20 bits for 1.831.000 HA which would yield 1.7 HA/bit, wherein 1 HA is 10000 M².

3. In a third circle, circle R3, there is encoded information for the individual tree, 26 bits 67 M, code time 30 years before reuse this would give approximately 2 M/HA/year (production wood, Douglas, max 400 trees per HA). Circles of the code are further described in relation to FIG. 1A.

Which means that 3 circles used in the two-dimensional code would be enough for the sustainable wood example. Furthermore, using a symbol size of 2 cm (in diameter) for the two-dimensional code, and 4 circles, would still yield a dot code diameter of 20 cm. This still leave some room to ruggedize the code.

Recognition of the two-dimensional code from an image capture taken with for example a 4 Mega pixel camera (4 Mpix˜2000*2000 pix). The capture of the image is made from a truck and shows the cut edges of the trees: 2.5 M*3 M=>1.5 mm/pix. Dot representation in 12*12 pixel in the picture.

The present disclosure has at least the advantage to enable responsible forestry with the use of communication networks such as the 5G ecosystem. A further advantage is that lower administrative and inspection burden for sustainable forestry is enabled. A further advantage is that increased traceability of “FSC” marked wood products is achieved. A further advantage is that support for governmental forestry programs is enabled. A further advantage is that the disclosure makes it difficult to insert illegal wood in the production cycles.

FIG. 1A illustrates concentric circles 120 and a common center 130 of a two-dimensional code according to one or more embodiments of the present disclosure.

FIG. 1A illustrates how the concentric circles 120 comprises a plurality of circles e.g., R0-R3, each circle having a different/unique size. Of course, more circles can be used in case a lager payload is desired. Alternatively, fewer circles may be used in case a smaller payload is required with a minimum of two circles, R0 and R1. In the example shown in FIG. 1A, the concentric circles are arranged equidistant along a radius intersecting the common center 130. However, any suitable distance between circles may be used.

FIG. 1A illustrates how the concentric circles 120 comprises an innermost circle R0, an outermost circle R3 and intermediate circles R1-R2.

In one non-limiting example, the second most inner circle R1 to the outer most circle R3 represent numerical values or payload data, and the inner most circle R0 represents a reference pattern portion, e.g., indicative of a common center.

FIG. 1B illustrates a two-dimensional code 100 according to one or more embodiments of the present disclosure.

As can be seen from FIG. 1B, the two-dimensional code 100 is based on information represented by symbols arranged on a plurality of concentric circles 120, R0, R1, R2, R3, R4, R5, R6 aligned with a common center 130. FIG. 1B indicates a position 110 arranged on a concentric circle. In particular, the two-dimensional code 100 comprises a plurality of positions 110 arranged along the plurality of concentric circles 120.

The plurality of concentric circles 120 has a common center 130 and is arranged substantially on a two-dimensional plane. E.g., a rugged surface such as the end of a cut tree, a lid of a glass jar, a surface of wall, or a surface of a billboard.

Each of the positions 110 indicates either presence of a symbol or absence of a symbol. Each of the presence or absence of the symbol at each position is optically readable and represents a data value set associated to each of the plurality of positions. In one example, a presence represents a digital 1 value, and an absence represents a digital 0 value. Naturally, an alternative embodiment is where a presence can represent a digital 0 value and an absence can represent a digital 1 value.

A reference pattern comprises at least one portion. Alternatively, the reference pattern may comprise two or more portions.

A first reference pattern portion 140 includes a set of positions selected from the plurality of positions and indicates at least the common center of the plurality of concentric circles. The first reference pattern portion comprises all positions along the inner most circle of the plurality of concentric circles. All the positions along the inner most circle of the plurality of concentric circles encircles an empty space/area, which in turn is enclosing the common center 130.

Further all positions along the inner most circle indicate presence of a symbol. In one example, the symbol is a dot, and all the dots are present on the inner circle.

FIG. 2 illustrates identification of a common center 130 according to one or more embodiments of the present disclosure. FIG. 2 illustrates a first reference pattern portion 140 where symbols in the form of dots are arranged along an inner most circle of the plurality of concentric circles 120. All positions are present on the inner most circle.

A first pair of symbols/dots is identified, and a first perpendicular bisector line is calculated for the first pair.

A second pair of symbols/dots is identified, and a second perpendicular bisector line is calculated for the second pair. The members of the pairs need not to be exclusive, and a minimum of three adjacent symbols/dots can be used to form the pairs. In an embodiment the first pair of symbols are adjacent symbols. In an embodiment the second pair of symbols are adjacent symbols.

The first and second bisector line intersects at a point that forms an estimation of the common center 130. In other words, the perpendicular bisector line based on the center of any pair of symbols will pass through the common center 130. With two pairs, the two perpendicular bisector lines will cross the two-dimensional code center. Two symbols of the two pairs, i.e., one symbol from each pair, may even be selected as the same symbol, so that with a minimum of three symbols the common center 130 can be determined.

By calculating perpendicular bisector line for additional pairs of symbols an improved accuracy of the estimated common center can be achieved. E.g., by calculating an average of estimations of the common center 130 for all calculated perpendicular bisector lines.

In any processing of the image depicting a scene comprising the one or more two-dimensional code, the estimated common center 130 is used for any rotating operations in relation to the two-dimensional code 100.

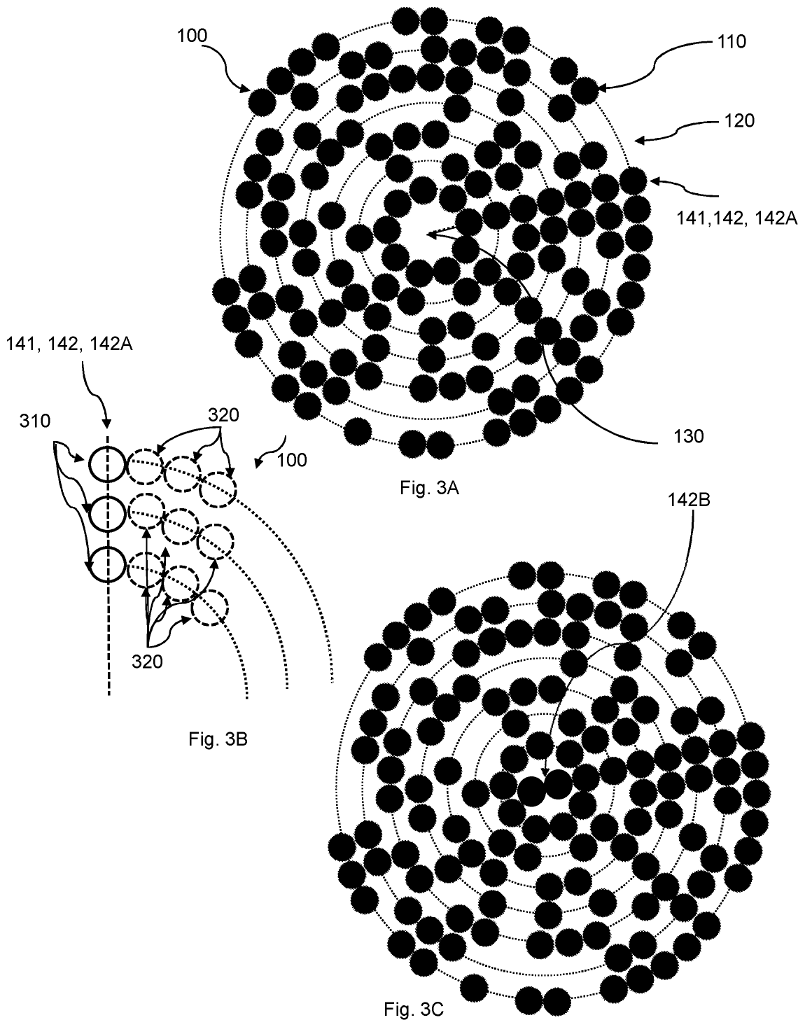

FIG. 3A illustrates identification of a rotational reference according to one or more embodiments of the present disclosure. In this embodiment, the second reference pattern portion 141 indicates a rotational reference 142 of the plurality of positions around the common center 130.

In this embodiment, the rotational reference 142 is arranged in the form of a straight line 142A, e.g., a radius or radius line, extending from the common center 130 to the outer most circle of the plurality of concentric circles 120. The symbols arranged on this straight line 142A indicates the start position for reading the code of each respective circle. In some embodiments the straight line 142A may be referred to as a start line

In one illustrating example, symbols which are part of the rotational reference 142 or the second reference pattern portion 141 are arranged on each respective circle of the plurality of concentric circles 120, and on the straight line 142A from common center 130 to the outer most circle of the plurality of concentric circles 120.

The present disclosure excludes configurations of positions where any other positions of the plurality of positions 110 fulfil the condition above. In other words, false detection of the straight line 142A is avoided or at least the risk is significantly reduced by avoiding positions that align along a straight line or radius for other than symbols forming the rotational reference or the second reference pattern portion 141.

FIG. 3B illustrates rotational reference 142 and payload data according to one or more embodiments of the present disclosure. In one embodiment, the rotational reference comprises one or more starting/first symbols 310 (which center point is on the respective circle) which is always present and part of the second reference pattern portion 141 or rotational reference 142.

Starting/first symbols, or symbols part of the rotational reference 142 are show as solid circles 310 and further exemplifying payload symbols 320 are shown as dashed circles. The payload symbols can either be present or absent.

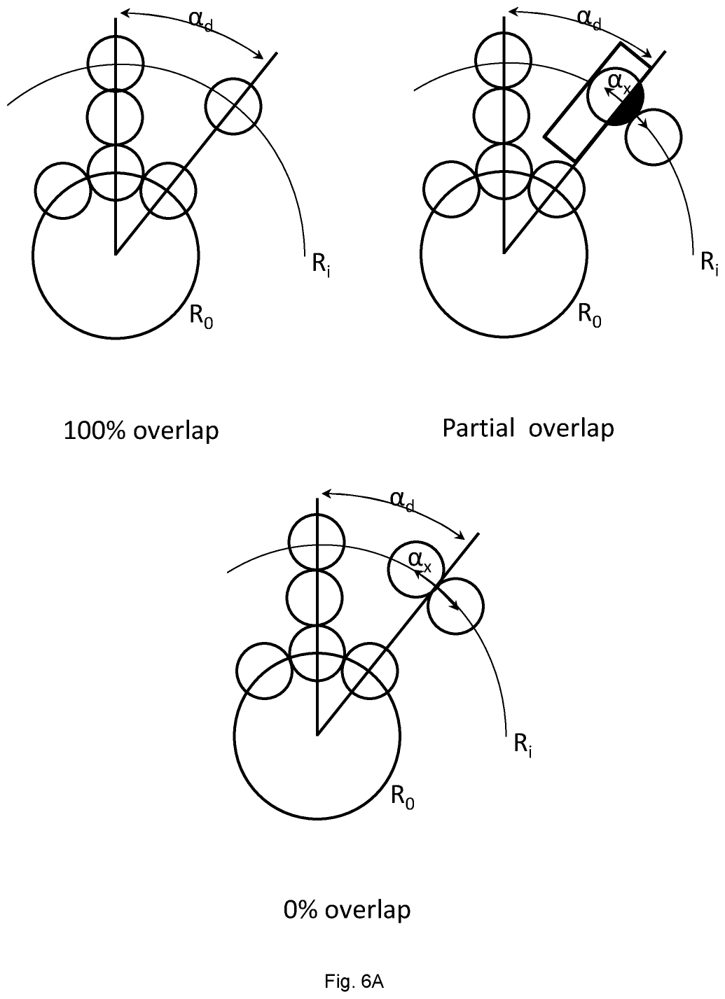

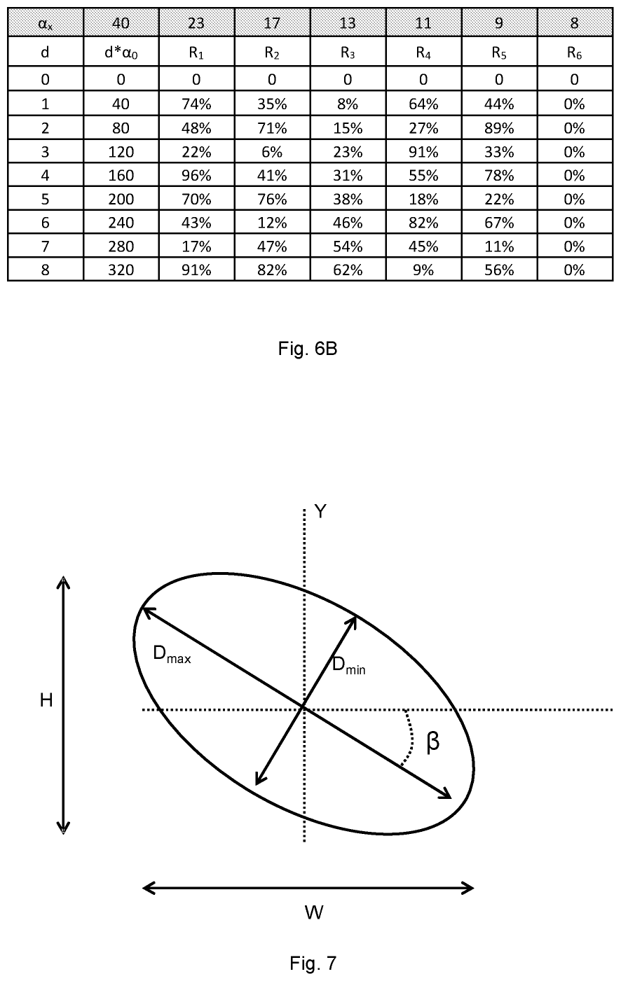

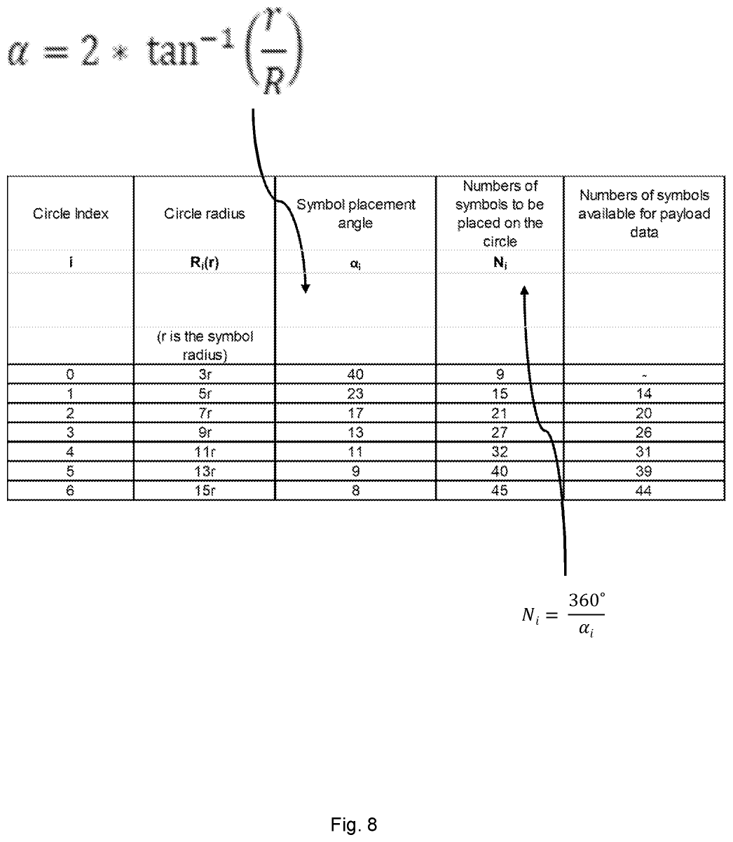

This ensures that no “false” line can be formed by payload symbols 320 which are not part of the rotational reference. This might require that a gap between last dot in a circle and the line 142A is spread over the circle or even that one potential symbol is excluded when needed. In one example, the radius of the blank space formed in the center of the inner most circle is configured to 2* radius of the symbols. That is, the radius of the first concentric circle R0 subtracting the radius of the symbols multiplied by 2. In other words, the plurality of positions 110 allocated for payload symbols 320 are arranged such that alignment along a straight line from common center 130 to the outer most circle of the plurality of concentric circles 120 is excluded. Angles of positions are further described in relation to FIG. 6B and FIG. 8.

The payload symbols 320 on each position of each respective circle are following the respective starting/first symbol in a direction the code is read and are arranged on each respective circle. The payload symbols 320 represents binary digits or payload data of the code and are read along the respective circle starting with the symbol following the starting/first symbol/s or symbol/s part of the rotational reference.

In the examples shown in FIG. 3A-C, the direction the code is read/decoded can be a clockwise direction. However, it is understood that a counterclockwise reading direction may equally be used without departing from the present disclosure.

A major advantage of the two-dimensional code 100 is that much higher code density is possible e.g., less circles are required for a certain number of code bits.

In other words, in this embodiment, the start position of the numerical value part of the code on each circle code is based on a rotational reference in the form of a line from center of the two-dimensional code outward, on which all symbols are exactly with their center on this line and present for each circle of the plurality of concentric circles 120. The symbols, arranged on the inner most circle, are all present.

In one embodiment, the number of circles used in the two-dimensional code is derived from the second reference pattern portion being indicative of the rotational reference 142.

In the example illustrated in FIG. 3A-B, the number of symbols, e.g., symbols that are detected/identified as present along the line 142A or radius/rotational reference 142 determine how many circles are used in the two-dimensional code. The presence of consecutive symbols along the line 142A/rotational reference 142 indicates that the corresponding circles in the code are used in the two-dimensional code. The absence of a symbol along the line 142A/rotational reference 142 indicates that the corresponding circle and any outer circles in the code are not used in the two-dimensional code.

In one embodiment, the two-dimensional code is configured to comprise a minimum of 3 circles. This is to ensure that an acceptable accuracy for detecting the straight line 142A. In some embodiments this can be described as a start line.

FIG. 3C illustrates extension symbols 142B of the rotational reference 142 according to one or more embodiments of the present disclosure.

In one embodiment the rotational reference 142, further comprises extension symbols 142B encircled by the inner most circle of the plurality of concentric circles 120 and arranged on a straight line from common center 130 to the outer most circle of the plurality of concentric circles 120. In an embodiment the straight line from common center 130 is the same line 142A.

This has the effect of enabling improved detection of the start line by adding two extra dots to the rotational reference 142.

In one example, two extension symbols 142B provide a line through the common center 130 on which the start line must lay. The symbols will all be present and have their center exactly on the straight line 142A.

This embodiment is especially advantageous if the inner circle has a radius equal to three times the symbol radius. Even more advantages is if any of the circles, when counted from the common center, have a radius equal to (2n+1) multiplied by the symbol radius where n is the circle as counted from the common center, e.g., 1, 2, 3, 4 through to n number of circles. See FIG. 8. column 1 and column 2.

Another advantage is that the common center 130 detection/identification is more accurate as the common center 130 must be located exactly in the middle of the two extension symbols' centers.

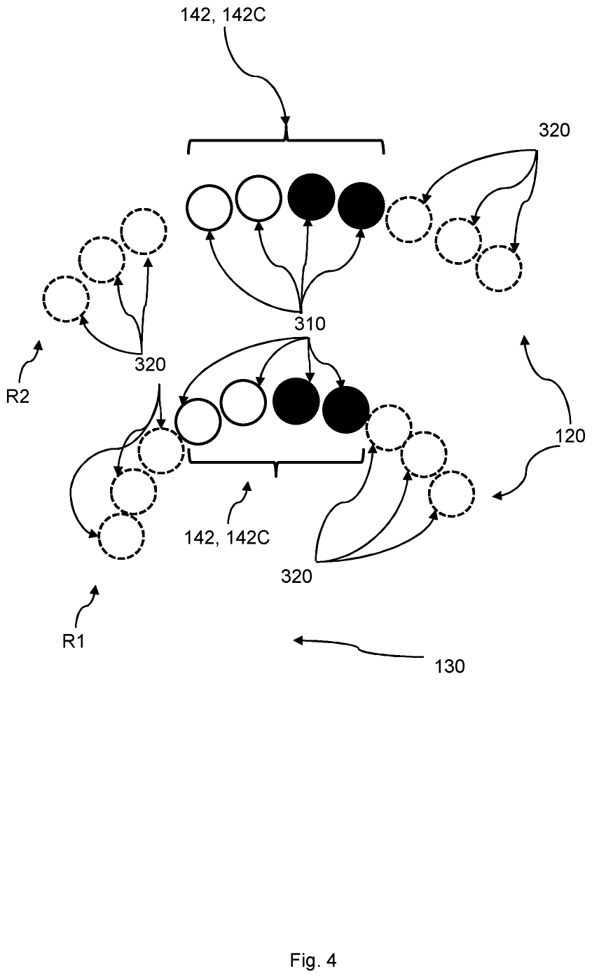

FIG. 4 illustrates identification of a rotational reference 142 according to one or more embodiments of the present disclosure. In this embodiment, the second reference pattern portion 141 indicates a rotational reference 142 of the plurality of positions around the common center 130.

In FIG. 4, symbols 310 part of the rotational reference 142 are show as solid circles and payload symbols 320, used to carry payload data or numerical values, are shown as dashed circles.

In this embodiment, the rotational reference 142 is arranged as a sequence 142C of symbols of a predetermined length, where the sequence 142C is repeated on each circle of the plurality of concentric circles 120. In other words, the sequence comprises one or more subsequent symbols arranged on a circle of the plurality of circles 120. The symbols 310 which are part of the rotational reference 142 indicates the start position for reading the code of each respective circle.

In one illustrating example, symbols which are part of the rotational reference 142 or the second reference pattern portion 141 are arranged on each respective circle of the plurality of concentric circles 120. In the example given in FIG. 4, a two-dimensional code is shown as having two concentric circles for payload, e.g., R1 and R2.

Symbols 310 part of the rotational reference 142 are show as solid circles, and additional payload symbols 320, used to carry payload data, are shown as dashed circles.

In other words, four symbols are part of the rotational reference 142 (or start/initial symbols) and six symbols are used to encode payload data or numerical values. The example sequence 142C of symbols 310 part of the rotational reference 142 is “0011” in binary format, represented by two subsequent positions where there is no presence of a symbol and a further two subsequent positions where there is presence of a symbol. Further examples may be binary sequences “0111” and “0001”. The additional symbols 320 shown as dashed circles may be positions with or without presence.

Optionally, the initial symbols of the rotational reference 142/second reference pattern portion 141 of each circle are all bisected by an imaginary line originating from the common center.

The additional symbols 320 on each position of each respective circle are following the respective sequence of symbols and are arranged on each respective circle. The additional symbols 320 represents binary digits or payload data of the code and are read along the respective circle starting with the symbol following the starting/first symbol 310.

In the examples shown in FIG. 4, the direction the code is read/decoded is a clockwise direction. However, it is understood that a counterclockwise reading direction may equally be used without departing from the present disclosure.

In one embodiment, additional space is arranged between symbols of the symbols 310 part of the rotational reference and the additional symbols 320.

The main advantage of this embodiment is that the rotational reference may vary/be unique for each circle. A ruggedizing algorithm is used so that the sequence of symbols does not occur in the additional symbols 320. This can be done with known techniques like “gray coding, ruggedizing algorithm etc. A further advantage is that there is no need to identify a start line, as described in relation to FIG. 3A-C. It is possible to just start scanning the dots, and after having found the start sequence in the circle, to then start decoding the dots of the numerical value/the additional symbols 320.

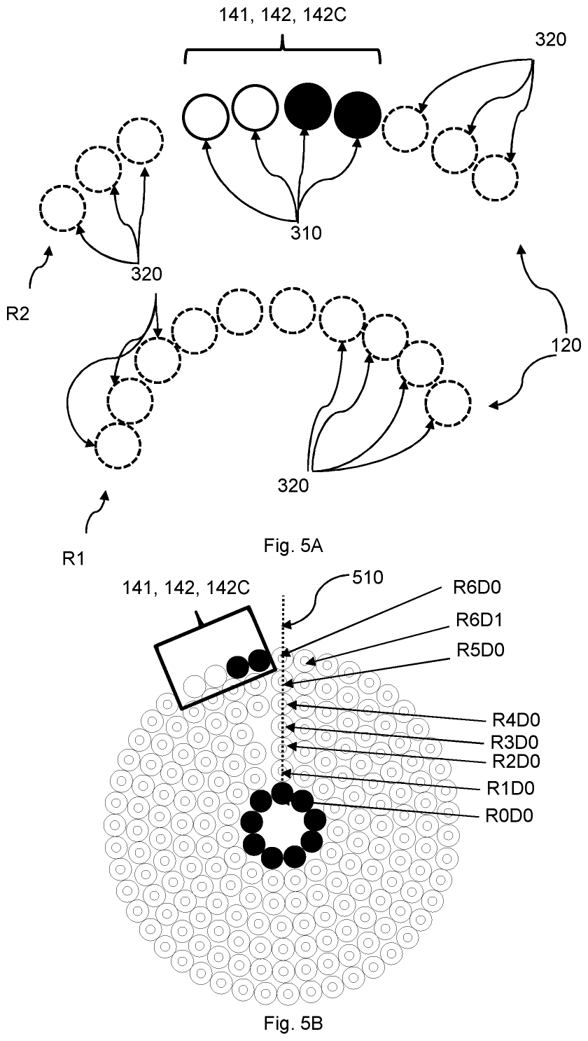

FIG. 5A illustrates identification of a rotational reference 142 according to one or more embodiments of the present disclosure. In this embodiment, the second reference pattern portion 141 indicates a rotational reference 142 of the plurality of positions around the common center 130.

In FIG. 5A, symbols 310 part of the rotational reference are show as solid circles and additional symbols 320, used to carry payload data, are shown as dashed circles.

In this embodiment, the rotational reference 142 is arranged as a sequence of symbols of a predetermined length, where the sequence 142C is only arranged on the outer most circle of the plurality of concentric circles 120. The symbols 310 which are part of the rotational reference indicates the start position for reading the code of each respective circle.

In one illustrating example, positions 110 which are part of the rotational reference 142, or the second reference pattern portion 141 are arranged only on the outmost/largest circle of the plurality of concentric circles 120. This reference pattern portion of the outer most circle infers the start of reading code on the remaining circles.

In the example given in FIG. 5A, The sequence of symbols part of the rotational reference 142 is “0011” in binary format, represented by two subsequent positions where there is no presence of a symbol and a further two subsequent positions where there is presence of a symbol. Further examples may be binary sequences “0111” and “0001”.

The additional symbols 320 on each position of each respective circle are following the respective sequence of symbols and are arranged on each respective circle. The additional symbols 320 represents binary digits or payload data of the code and are read along the respective circle starting with the symbol following the starting/first symbol 310.

In the examples shown in FIG. 5A, the direction the code is read/decoded is shown as clockwise. However, it is understood that a counterclockwise reading direction may equally be used without departing from the present disclosure.

In one embodiment, the first symbol/s (defined in the direction the code is read) or the additional symbols 320 is arranged on a line.

This embodiment has the extra advantage that for all circles, with the exception of the outer circle, a ruggedizing algorithm such as gray coding or the like is not needed. A further advantage is that a higher code density is achieved, as more symbols are now available for payload data. The rotational reference 142 of the outer circle shall be ruggedized as described in the previous embodiment.

In one embodiment, the additional symbols 320 of the outer circle does not carry payload data, and instead carry a Cyclic Redundancy Check, CRC, and/or hash to verify the correctness and to improve reliability. This can be used in all the embodiments described in relation to FIG. 3A-C, FIG. 4, and FIG. 5A. In the case that this option is combined with a sequence of symbols as described in relation to FIG. 4, the sequence of symbols shall not occur in the hash/CRC.

In one embodiment, the sequence of symbols described in relation to FIG. 4 or FIG. 5A is defined as “01010101”. This has the advantage that it makes the recognition of the sequence of symbols easier. Further, the sequence of symbols makes detection of the presence of a two-dimensional code in a captured surface easier by using the pattern as an offset frequency for low pass post filtering for the detected dots to be able to discard scratches in the dots. The sequence of symbols also eases the resizing of the two-dimensional code before applying detection, e.g., to compensate for view angle and surface angles of the two-dimensional code.

FIG. 5B further illustrates identification of a rotational reference 142 according to one or more embodiments of the present disclosure. FIG. 5B illustrates a two-dimensional code 100 having concentric circles comprising six circles R0-R6. The second reference pattern portion 141 are arranged only on the outmost/largest circle of the plurality of concentric circles 120. This reference pattern portion of the outer most circle infers the start of reading code on the remaining circles. The first position the start of reading code on the remaining circles R0D0, R1D0, R2D0, R3D0, R4D0, R5D0, R6D0 are aligned along a line 510 inferred by the second reference pattern portion 141 on the outmost/largest circle of the plurality of concentric circles 120.

FIG. 6A illustrates details of identification of a rotational reference according to one or more embodiments of the present disclosure.

To enable identification of the symbols arranged on a line, as described in relation to FIG. 3A-C, the center of the symbols of consecutive circles should be on a line 142A. For symbols on line 142A the center will be exactly on the line 142A. For other lines from common center outward passing through a center of a symbol on the most inner circle the symbols in other outer circles should not all have 100% overlap to avoid false detection of the line 142A. In case of 100% overlap, the symbol on circle Ri has its center exactly on the line 142A or the other line. With 0% overlap two consecutive circles have a center each having exactly 1 symbol radius distance from the other line. With partial overlap the symbol on circle Ri has it center not on the line 142A but closer than a radius distance from the other line.

FIG. 6A illustrates a 100% overlap, a partial overlap dd/ax and a 0% overlap.

For identification of a rotational reference 142, 100% overlap in all consecutive circles is already excluded by placing the symbols with a distance of their centers of twice the symbol radius. An overlap of 0% in all consecutive circles is to be considered as an ideal situation. Most of the time, there will be a partial overlap where a symbol is partly on the line.

The distance between the symbol center and the radius is denoted ad. The angular position of a symbol, relative to the start position/rotational reference 142 is denoted ax. The overlap is defined as:

$$1 - 2 * ad / ax$$

If the overlap is less than 10-20%, it may be difficult to detect the rotational reference 142. However, it is unlikely that all circles on the radius will have the same low overlap, therefore there is a low likelihood that a false line 142A/rotational reference 142 is detected. For the same reasons the inner most circle has a diameter at least 3 times the symbol diameter size. The overlap is stated for a symbol, such as a dot, having the center before the start line in the direction the code is read. A symbol having its center after the line is calculated as 100% minus that overlap.

FIG. 6B shows a table for an example of a two-dimensional code with 7 concentric circles. The table indicates index of symbols on the most inner circle and relative angles of rotation of symbols relative to the line 142A/rotational reference 142.

FIG. 6B shows the overlap probability, where the overlap probability is defined as where a symbol may or may not be present on a location on the circle, for a line running from the common center the two-dimensional code and a center of a symbol on the most inner ring. ‘d’ represents which of the 9 dots of the most inner circle. ‘d=0’ represent the symbol of the most inner circle on the line 142A. D*α₀ in the second column provides the angle between the line running through the center of symbol d of the most inner ring and the line 142A through symbol d=0 of the most inner circle.

In other words, the first column indicates the symbol index in the direction the code is read, and the second column indicates the angle between the line 142A and a line from two-dimensional code center through the center of the symbol on the most inner circle.

Row 1 of the table provides the angle αₓ between the center of consecutive symbols on a circle Rx.

Columns 3-8 provide the probability of non-overlap on each of the circles R1-R6 for a line through the center of symbol d on the most inner ring.

This value is defined as;

$$( d * α0 - α x * int ( \frac{d * α0}{α x} ) : α x$$

A probability of 0% indicates 100% overlap. A probability of 100% indicates no overlap. In practice only when the probability is less than 10-20% in all consecutive circles for a given d, it might provide potentially a false line 142A. The table is made for the situation of inner most concentric circle R0 has diameter that is 3 times the symbol diameter and thus is indicated that there is a low likelihood that a false line 142A is detected.

FIG. 7 illustrates some of extracted data according to one or more embodiments of the present disclosure. FIG. 7 illustrates a symbol in the form of a circular dot of a two-dimensional code, which when an image is captured, and depicting the two-dimensional code, appears to be oval in the image. In other words, the circle appears to be distorted in the image. FIG. 7 shows a maximum diameter of the oval Dmax, a minimum diameter Dmin, a height H, a width W and an angle β between a horizontal axis of the field of view of the image and an axis intersecting the oval along the maximum diameter of the oval Dmax.

FIG. 8 shows an example of code characteristics according to one or more embodiments of the present disclosure. The table shows index of circles in the two-dimensional code, circle radius, symbol placement angle, number of symbols placed on the circle and number of symbols available for coding. The index of circles in the two-dimensional code has the closest circle to the common center starting at index i equal to 0, with each additional circle increasing the index by 1.

The code described above, can also be described as:

A two-dimensional code 100 comprising:

a plurality of positions 110 arranged along a plurality of concentric circles 120. The plurality of concentric circles has a common center 130 and is arranged substantially on a two-dimensional plane. The two-dimensional plane or surface may have an arithmetical mean roughness Ra value indicating the absolute average relative between peaks and valleys to the base length.

In embodiments, the Ra value of the two-dimensional plane or surface is in the 0.025 μm-4000 μm. A more preferable surface roughness would be in the range of 0.025 μm-2000 μm. To describe a quality of the surface, a fine roughness on a surface would comprise Ra values between 0.025 μm-500 μm. A medium rough surface would be between 500-2000 μm. A high roughness surface would be a surface roughness greater than 2000 μm.

The diameter size of the symbols is in the range of 1 mm-100 cm, more preferable in the range of 1 mm-50 cm, even more preferable in the range of 1 cm-50 cm and most preferable in the range of 1 cm-10 cm, for example 2 cm or 5 cm.

Each of said positions is indicating presence of a symbol or absence of a symbol. Each presence or absence of a symbol at each position being optically readable and representing a data value set or assigned to each of the plurality of positions.

The two-dimensional code further comprises a first reference pattern portion 140 including a set of the plurality of positions indicating at least the common center. In other words, the plurality of positions typically comprises either starting/first symbols or symbols 310 part of the rotational reference, or the plurality of positions typically comprises additional symbols 320 used for encoding payload data of the code. The first reference pattern portion comprises all positions along the inner most circle of the plurality of concentric circles. Wherein all positions along the inner most circle indicate presence of a symbol. In other words, all positions on/along the inner most circle all indicate presence of a symbol. In one example, all positions on/along the inner most circle have a dot printed on each respective position.

In one embodiment, the two-dimensional code comprises a second reference pattern portion indicative of a rotational reference of the plurality of positions around the common center.

In one embodiment, the indication of the rotational reference is indicated by one or more reference positions arranged on at least one circle of the plurality of concentric circles. In other words, the rotational reference is arranged over one or more circles if the plurality of circles 120 and arranged on one or more positions of the plurality of positions 110.

In one embodiment, the second reference pattern portion comprises a position on two or more of the concentric circles arranged along a line intersecting the common center. In other words, the intersection of the radius or radius line discussed above forms together with a selection of the plurality of circles positions for the second reference pattern portion.

In one embodiment, the second reference pattern portion comprises a predetermined sequence of presence or absence of a symbol. In other words, the second reference pattern portion comprises the start sequence discussed above in relation to FIG. 4 and FIG. 5A-B.

In one embodiment, the symbol is a filled circle or dot. E.g., as shown in FIG. 1A-B.

In one embodiment, the inner most circle of the plurality of concentric circles generates a blank space in the center of the plurality of concentric circles, the blank space being larger than the size of a symbol. As discussed above, the diameter of the blank space is at least three times the height or diameter of the symbol, e.g., a dot.

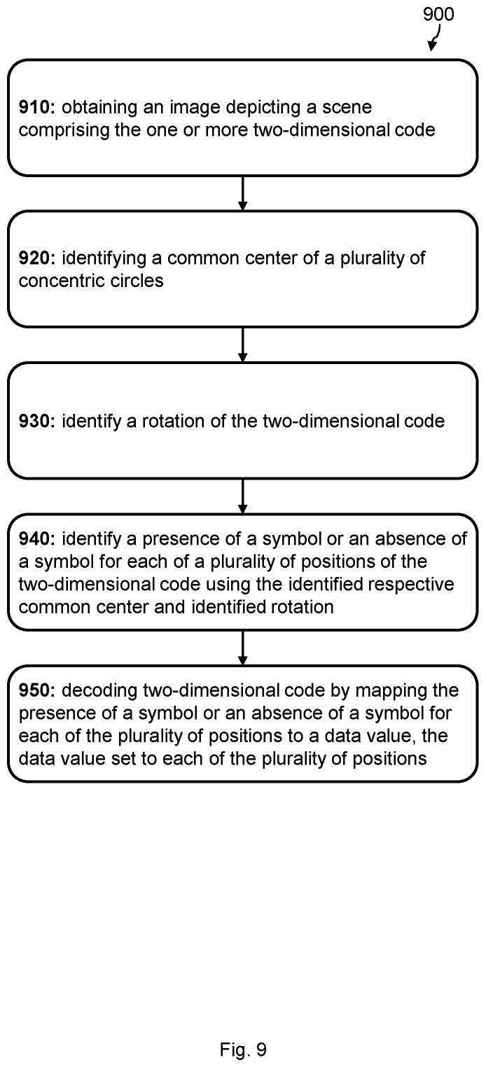

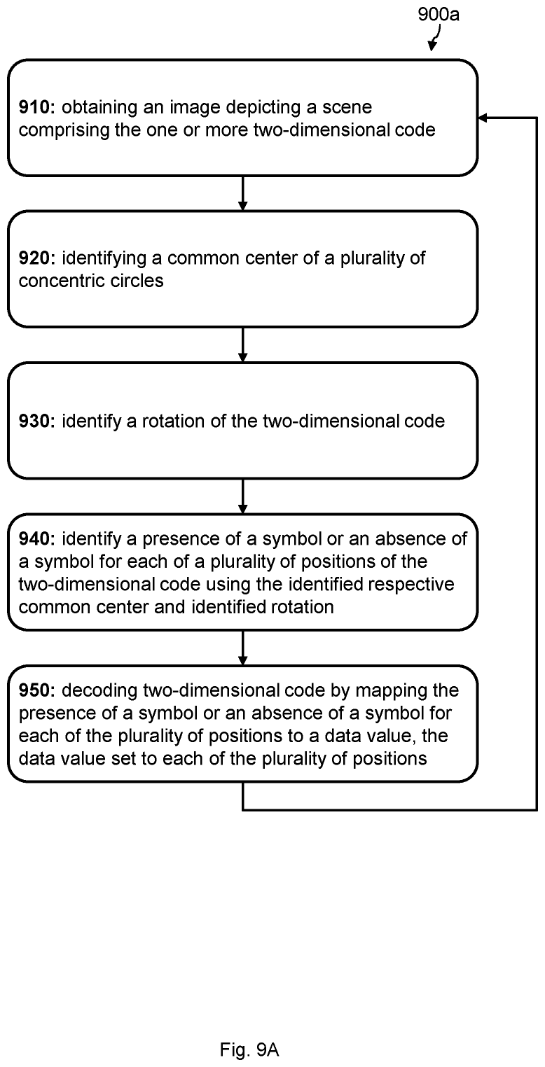

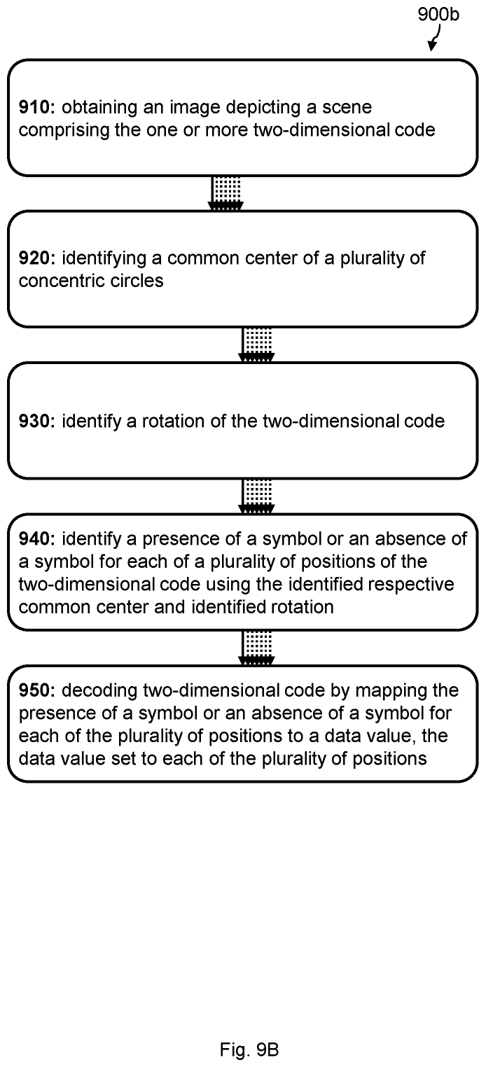

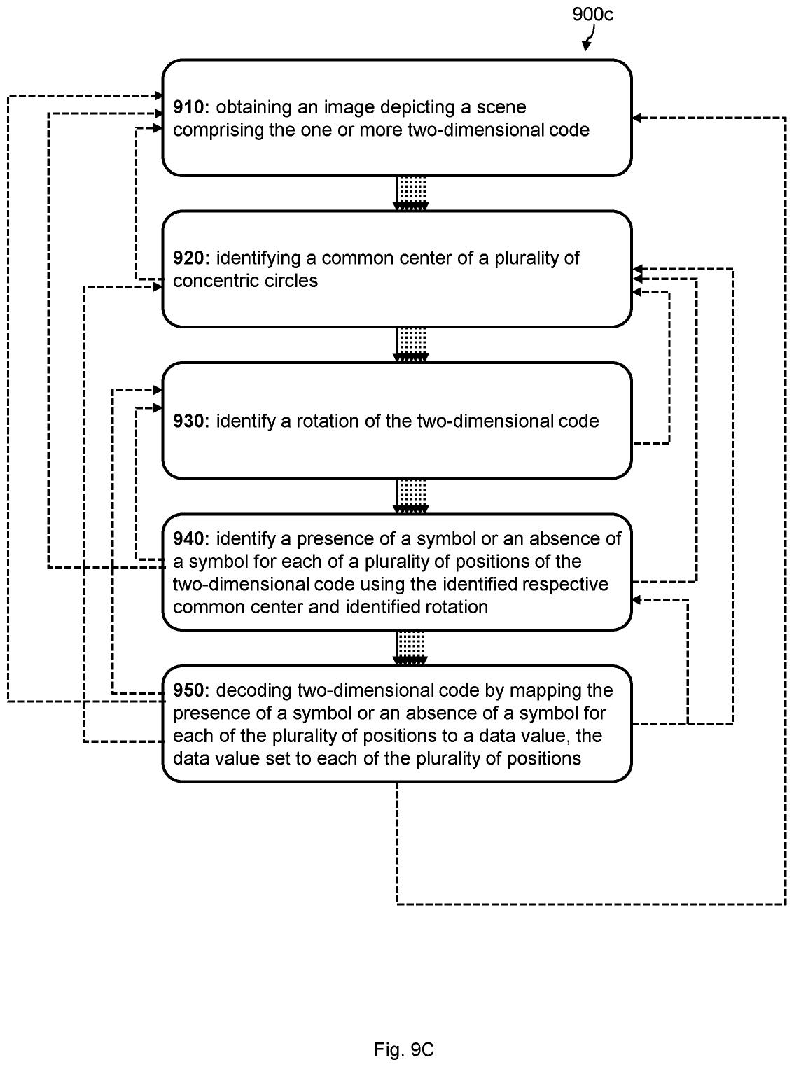

FIG. 9 shows a flowchart of a method 900 according to one or more embodiments of the present disclosure. The method is configured to decode one or more two-dimensional codes described herein. The method comprises:

Step 910: obtaining an image depicting a scene comprising the one or more two-dimensional codes. The image may be obtained using a camera, e.g., a camera in a smartphone.

If two or more two-dimensional code is comprised in the scene the steps 920-950 are performed for each of the two-dimensional codes.

For two or more two-dimensional codes the steps 920-950 can be performed in a sequence, e.g., first perform steps 920-950 for one of the two-or more dimensional code, then after the first two-dimensional code is processed through all steps 920-950, progress onto the next two-dimensional code and perform steps 920-950. This proceeds for all two-dimensional codes. For an example illustration of this embodiment, see FIG. 9A method 900a. Alternatively, these steps 920-950 can be performed in parallel, e.g., perform step 920 for all detected codes, then perform step 930 for all detected codes, and then perform step 940 for all detected codes, and then perform step 950 for all detected codes. For an example illustration of this embodiment, see FIG. 9B method 900b. A person skilled in the art will know that there can be a mixture of these two alternatives e.g., performing some steps in sequence for one code and some in parallel for several codes, e.g., perform step 920 for all two-dimensional codes, and then perform step 930-950 for each detected two-dimensional code, one at a time. For an example illustration see FIG. 9C method 900c.

Step 920: identifying a common center of a plurality of concentric circles. Identifying the common center 130 is further described in relation to FIG. 2.

Step 930: identify a rotation of two-dimensional code. Identifying the rotation of the two-dimensional code is further described in relation to FIG. 3A-C, FIG. 4, FIG. 5A-B.

Step 940: identify a presence of a symbol or an absence of a symbol for each of a plurality of positions of the two-dimensional code using the identified respective common center and identified rotation.

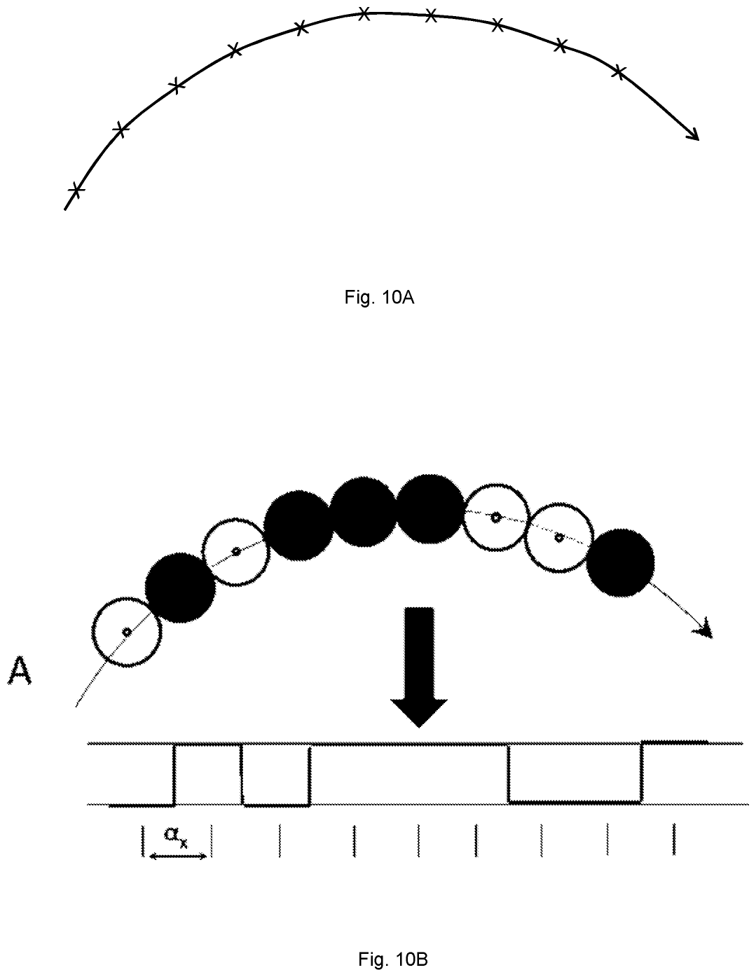

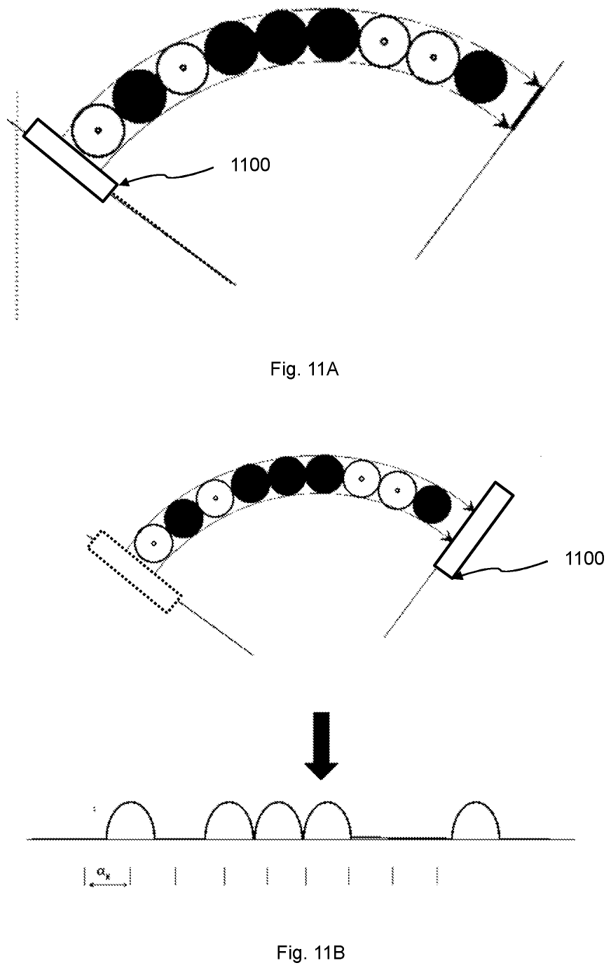

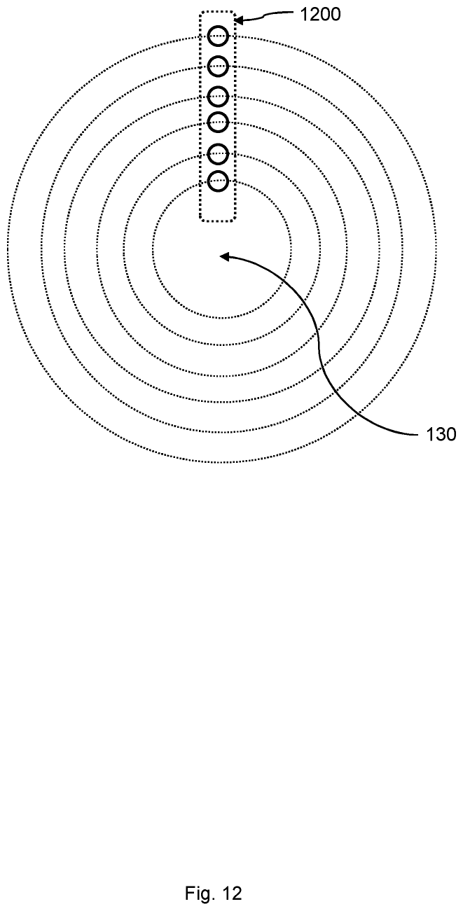

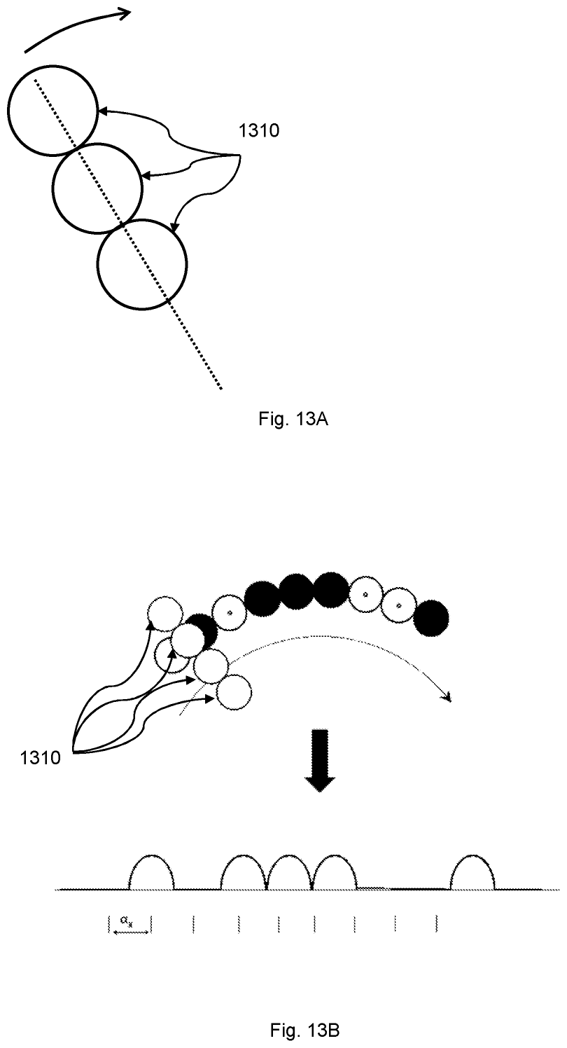

In an embodiment, the identification of a presence of a symbol or an absence of a symbol is performed by applying/overlaying a mask on the obtained image. The mask is provided with cut-outs formed like an outline of the symbols, e.g., circular holes in which dots can be detected. A symbol is detected in such a cut-out or detection area if a minimum number of pixels of the obtained image within the cut-out or detection area exceed a minimum pixel brightness value (thresholding). Identification of a presence of a symbol or an absence of a symbol is further described in FIG. 10A-B, FIG. 11A-B, FIG. 12, and FIG. 13A-B.

Step 950: decoding two-dimensional code by mapping the presence of a symbol or an absence of a symbol for each of the plurality of positions to a data value, the data value set to each of the plurality of positions.

In one embodiment, the presence of a symbol is mapped to digital “1” and an absence of a symbol is mapped to digital “0”.

In one embodiment, the position of the symbol and the identified presence or absence of the symbol is mapped to a data value by using a look-up table.

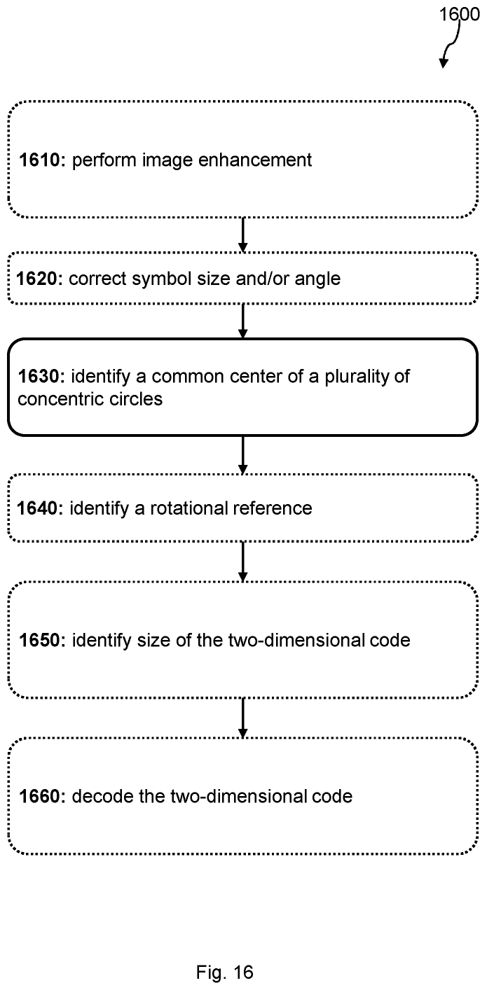

In one embodiment, identify the rotation of the two-dimensional code further comprises determining the size of the code, as further described in relation to FIG. 16.

In one example, the rotational reference 142 is in the form of a line or radius, and the size of the code is determined by counting the number of consecutive symbols that are present along the line or radius, the counted number of consecutive symbols then comprises the number of circles used of the plurality of circles. In other words, the size of the code is determined by counting the number of consecutive symbols in R0, R1, R2, R3 etc.

In one embodiment, the symbol is configured with a shape of a dot, wherein identifying a common center 130 comprises identifying a circular shaped area, wherein the circular shaped area is configured with a diameter of 3 times a diameter of the dot shape.

In one embodiment, decoding the two-dimensional code further comprises applying a mask to the obtained image.

In one embodiment, the method further comprising generating the mask by detecting a radial circle line using the symbols, wherein the radial circle line is formed by connecting detected centers of the symbols. This embodiment is further described in relation to FIG. 10A-B.

In one embodiment, the method further comprises generating the mask by forming a circular area defined by an inner and an outer radius, wherein the mask is generated as a radial segment 1100 of the circular area, wherein the mask is applied to the obtained image by rotating the radial segment around the common center. This embodiment is further described in relation to FIG. 11A-B.

In one embodiment, the method further comprises generating the mask by generating one detection area for each of the plurality of concentric circles, wherein the detection areas are positioned on each of the concentric circles and arranged along a line intersecting the common center, wherein the mask is applied to the obtained image by rotating the radial segment around the common center. The mask is typically configured to include one position on each circle of the plurality of circles 120.

In one embodiment, the method further comprises generating an enhanced image by performing image processing on the obtained image. Image processing is further described in relation FIG. 16, steps 1610 and step 1620.

In one embodiment, wherein the image processing comprises contrast/brightness adjustment.

In one embodiment, the image processing comprises symbol size correction.

In one embodiment, wherein the image processing comprises angle and/or projection correction

In one embodiment, identifying the common center comprises:
selecting at least two exclusive pairs, each pair comprising two positions where presence of a symbol has been identified and are on the same concentric circle,
identifying the common center of the plurality of concentric circles by detecting a position where a respective perpendicular bisector line of the at least two pairs intersect.

In one embodiment, wherein a subset of the plurality of positions are indicative of a rotational reference of the plurality of positions around the common center, wherein identify a rotation comprises detecting the position of the rotational reference of the one or more two-dimensional codes.

In one embodiment, the rotational reference is one or more reference positions arranged on at least one circle of the plurality of concentric circles.

In one embodiment, the one or more reference positions are arranged on at least two of the plurality of concentric circles along a line intersecting the common center.

In one embodiment, wherein the rotational reference is one or more reference positions arranged on at least one circle of the plurality of concentric circles, wherein the one or more reference positions are indicative of a predefined sequence of presence of a symbol or an absence of a symbol.

FIG. 9A illustrates an embodiment for a method 900a for two or more two-dimensional codes wherein the steps 920-950 are performed in a sequence, e.g., first perform steps 920-950 for one of the two-or more dimensional code, after the first two-dimensional code is processed through all steps 920-950, progress onto the next two-dimensional code and perform steps 920-950. This proceeds for all two-dimensional codes.

FIG. 9B illustrates an embodiment for a method 900b for two or more two-dimensional codes wherein the steps 920-950 are performed in parallel, e.g., perform step 920 for all of the two or more detected two-dimensional codes, then perform step 930 for all detected two-dimensional codes, and then perform step 940 for all detected two-dimensional codes, and then perform step 950 for all detected two-dimensional codes.

FIG. 9C illustrates an embodiment for a method 900c for two or more two-dimensional codes wherein the steps 920-950 are performed in a combination of sequence and parallel. For example, performing some steps in sequence for one code and some in parallel for several codes, e.g., perform step 920 for all two-dimensional codes, and then perform step 930-950 for each detected two-dimensional code, one at a time.

FIG. 10A illustrates detection areas for a first embodiment according to one or more embodiments of the present disclosure. The center of each position of the plurality of positions 110 arranged along the plurality of concentric circles 120 is used to place the center of the detection areas. The distance ax is needed to detect/identify presence or absence of a symbol see FIG. 6B the second row. In an embodiment, a radial ring line is detected for consecutive positions on a concentric circle. The radial ring line is formed by connecting detected centers of the positions of symbols.

FIG. 10B shows an example of identifying 940 and decoding 950 according to one or more embodiments of the present disclosure.

As can be seen from FIG. 10B, the presence of a symbol or an absence of a symbol is identified for each of a plurality of positions of the two-dimensional code using the identified respective common center and identified rotation. The sequence of identification is here (from left to right along the arrow indicating reading direction): absence, presence, absence, presence, presence, presence, absence, absence, and presence. This sequence of identification can then be decoded 950 as the bit sequence shown below: “010111001”.

FIG. 11A illustrates detection areas for a second embodiment according to one or more embodiments of the present disclosure.

The center of each position of the plurality of positions 110 arranged along the plurality of concentric circles 120 is used to place the detection areas. However, the detection areas are offset along a radius in relation to the center of each position of the plurality of positions 110, e.g., by 50% of the size/radius of the symbol.

In this method the radius is divided in segments e.g., radial segment 1100, where each segment covers a circle of the plurality of concentric circles 120. The segmented radius rotates, and each segment produces an output based on the sum of the pixels on the segment part of the radius line. This method has as main advantage that scratched two-dimensional code dots, especially those with radial or semi radial scratches are better detected. An additional advantage is that from the signal itself (low pass filter) the detection points for 0 and 1 bits can be decoded.

The presence of a symbol is typically mapped to digital “1” and an absence of a symbol is typically mapped to digital “0”.

An advantage of this embodiment is that the detection for the bits is better synchronized from the edges compared to the embodiment shown in FIG. 10A-B.

FIG. 11B shows an example of identifying 940 and decoding 950 according to one or more embodiments of the present disclosure.

As can be seen from FIG. 11B, the presence of a symbol or an absence of a symbol is identified for each of a plurality of positions of the two-dimensional code using the identified respective common center and identified rotation. The sequence of identification is here (from left to right along the arrow indicating reading direction): absence, presence, absence, presence, presence, presence, absence, absence, and presence. This sequence of identification can then be decoded 950 as the bit sequence shown below: “010111001”.

FIG. 12 illustrates detection areas for a third embodiment according to one or more embodiments of the present disclosure.

The center of each position of the plurality of positions 110 arranged along the plurality of concentric circles 120 and a radius or radius line is used to place the detection areas, one detection area for each circle. The detection areas are rotated over the circles. The detection areas are indicated by the dotted rectangle 1200

In one embodiment the starting/first symbols or symbols part of the rotational reference 142 are arranged with a size of 100% nominal size and the additional symbols 320 are arranged with 100% nominal size.

A further improvement for the embodiments shown in FIG. 11A-B, FIG. 12 and FIG. 13-A-B the reduction of noise contamination during identification/detection of symbols. The noise contamination can occur, due to for example the two-dimensional code being printed on a rough surface or scratches or other defects in the symbols. Therefore, a filtering stage can be added between the output signal and detection of bits. This can be implemented through applying a simple low pass filter or by applying integration, where the cut of frequency or integration time is determined from the dot angle αx of the circles. When the synchronization option is used as stated before this can be determined from the synchronization signal.

An advantage of this embodiment is that it eases the 0/1 detection out of the signals. A cut frequency can be set, but also determined as 2 or 4* the detected frequency in the synchronization signal when that option is used.

FIG. 13A illustrates details of the third embodiment according to one or more embodiments of the present disclosure.

FIG. 13A illustrate the detection areas 1310 arranged on a radius or radius line.

FIG. 13B illustrates details of the third embodiment according to one or more embodiments of the present disclosure.

FIG. 13B illustrates how the detection areas 1310 are rotated along the common center 130 over the plurality of concentric circles 120 to generate an output signal (shown on the bottom part of the figure).

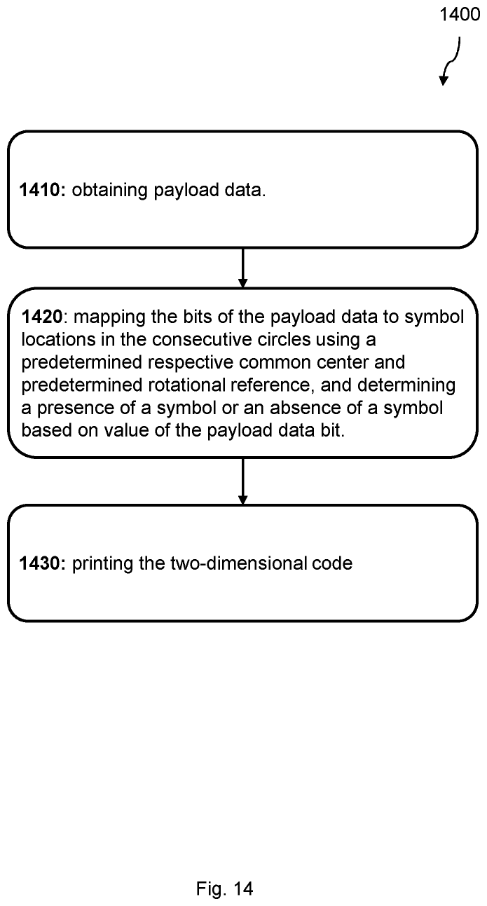

FIG. 14 shows a flowchart of a method 1400 according to one or more embodiments of the present disclosure. The method is configured to print one or more two-dimensional codes described herein. The one or more two-dimensional codes each comprising plurality of positions 110 arranged along a plurality of concentric circles 120, the plurality of concentric circles having a common center 130 and being arranged substantially on a two-dimensional plane. The method comprises:

Step 1410: obtaining payload data. The data may e.g., be data indicative of the described use case herein.

Step 1420: mapping the bits of the payload data to symbol locations in the consecutive circles using a predetermined respective common center and predetermined rotational reference, and determining a presence of a symbol or an absence of a symbol based on value of the payload data bit.

Step 1430: generating the two-dimensional code by printing symbols at positions of the plurality of positions 110 identified to have a presence of a symbol and not generating symbols at positions of the plurality of positions 110 identified not to have a presence of a symbol. The generating of the symbols may be performed for example, by an application of paint to the surface, an application of heat to the surface, an application of a material generating a figure in the shape of the symbol on the surface.

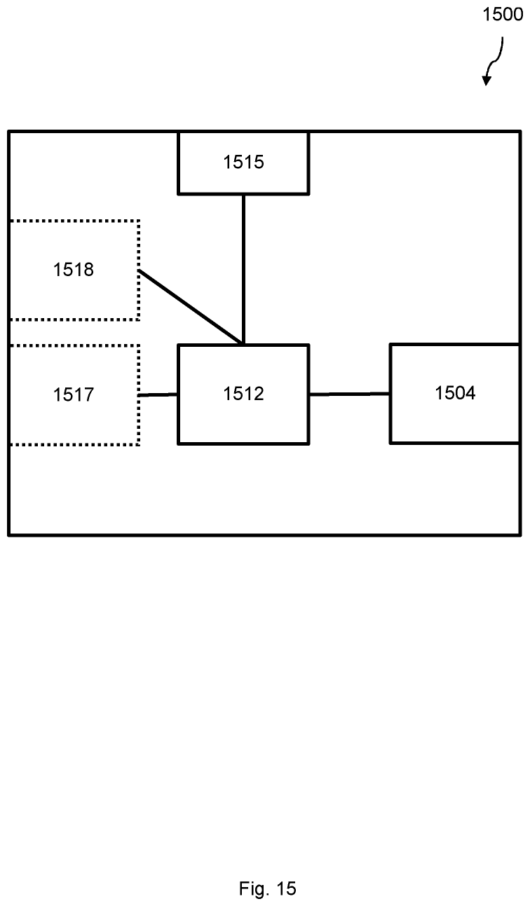

FIG. 15 shows details of a device 1500 according to one or more embodiments of the present disclosure.

The device 1500 may be in the form of a selection of any of device, a desktop computer, server, laptop, mobile device, a smartphone, a tablet computer, a smart watch etc. The device 1500 may comprise processing circuitry 1512. The device 1500 may optionally comprise a communications interface 1504 for wired and/or wireless communication. Further, the device 1500 may further comprise at least one optional antenna (not shown in figure). The antenna may be coupled to a transceiver of the communications interface 1504 and is configured to transmit and/or emit and/or receive wireless signals, e.g., in a wireless communication system, such as Long-Term Evolution, LTE, network.

In one example, the processing circuitry 1512 may be any of a selection of processor and/or a central processing unit and/or processor modules and/or multiple processors configured to cooperate with each-other. Further, the device 1500 may further comprise a memory 1515. The memory 1515 may contain instructions executable by the processing circuitry 1512, that when executed causes the processing circuitry 1512 to perform any of the methods and/or method steps described herein.

The communications interface 1504, e.g., the wireless transceiver and/or a wired/wireless communications network adapter, which is configured to send and/or receive data values or parameters as a signal to or from the processing circuitry 1512 to or from other external nodes in an embodiment, the communications interface 1504 communicates directly between nodes or via a communications network.

In one or more embodiments the device 1500 may further comprise an input device 1517, configured to receive input or indications from a user and send a user-input signal indicative of the user input or indications to the processing circuitry 1512.

In one or more embodiments the device 1500 may further comprise a display 1518 configured to receive a display signal indicative of rendered objects, such as text or graphical user input objects, from the processing circuitry 1512 and to display the received signal as objects, such as text or graphical user input objects.

In one embodiment the display 1518 is integrated with the user input device 1517 and is configured to receive a display signal indicative of rendered objects, such as text or graphical user input objects, from the processing circuitry 1512 and to display the received signal as objects, such as text or graphical user input objects, and/or configured to receive input or indications from a user and send a user-input signal indicative of the user input or indications to the processing circuitry 1512.

In one or more embodiments the device 1500 may further comprise one or more sensors (not shown).

In embodiments, the processing circuitry 1512 is communicatively coupled to the memory 1515 and/or the communications interface 1504 and/or the input device 1517 and/or the display 1518.

In embodiments, the communications interface and/or transceiver 1504 communicates using wired and/or wireless communication techniques.

In embodiments, the one or more memory 1515 may comprise a selection of a hard RAM, disk drive, a floppy disk drive, a magnetic tape drive, an optical disk drive, a CD or DVD drive (R or RW), or other removable or fixed media drive.

In a further embodiment, the device 1500 may further comprise and/or be coupled to one or more additional sensors (not shown) configured to receive and/or obtain and/or measure physical properties pertaining to the device or the environment of the device and send one or more sensor signals indicative of the physical properties to the processing circuitry 1512.

It is to be understood that a device comprises any suitable combination of hardware and/or software needed to perform the tasks, features, functions, and methods disclosed herein. Moreover, while the components of the device are depicted as single boxes located within a larger box, or nested within multiple boxes, in practice, a device may comprise multiple different physical components that make up a single illustrated component (e.g., memory 1515 may comprise multiple separate hard drives as well as multiple RAM modules).

Similarly, the device 1500 may be composed of multiple physically separate components, which may each have their own respective components.

The communications interface 1504 may also include multiple sets of various illustrated components for different wireless technologies, such as, for example, GSM, WCDMA, LTE, NR, Wi-Fi, or Bluetooth wireless technologies. These wireless technologies may be integrated into the same or different chip or set of chips and other components within the device 1500.

Processing circuitry 1512 is configured to perform any determining, calculating, or similar operations (e.g., certain obtaining operations) described herein as being provided by a device 1500. These operations performed by processing circuitry 1512 may include processing information obtained by processing circuitry 1512 by, for example, converting the obtained information into other information, comparing the obtained information, or converted information to information stored in the device, and/or performing one or more operations based on the obtained information or converted information, and as a result of said processing making a determination.

Processing circuitry 1512 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other device 1500 components, such as device readable medium, computer 1500 functionality. For example, processing circuitry 1512 may execute instructions stored in device readable medium 1515 or in memory within processing circuitry 1512. Such functionality may include providing any of the various features, functions, or benefits discussed herein. In some embodiments, processing circuitry 1512 may include a system on a chip.

In some embodiments, processing circuitry 1512 may include one or more of radio frequency, RF, transceiver circuitry and baseband processing circuitry. In some embodiments, RF transceiver circuitry and baseband processing circuitry may be on separate chips or sets of chips, boards, or units, such as radio units and digital units. In alternative embodiments, part or all of RF transceiver circuitry and baseband processing circuitry may be on the same chip or set of chips, boards, or units

In certain embodiments, some or all the functionality described herein as being provided by a device 1500 may be performed by the processing circuitry 1512 executing instructions stored on device readable medium 1515 or memory within processing circuitry 1512. In alternative embodiments, some or all the functionalities may be provided by processing circuitry 1512 without executing instructions stored on a separate or discrete device readable medium, such as in a hard-wired manner. In any of those embodiments, whether executing instructions stored on a device readable storage medium or not, processing circuitry 1512 can be configured to perform the described functionality. The benefits provided by such functionality are not limited to processing circuitry 1512 alone or to other components of device 1500 but are enjoyed by device 1500, and/or by end users.

Device readable medium or memory 1515 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1512. Device readable medium 1515 may store any suitable instructions, data, or information, including a computer program, software, an application including one or more of logic, rules, code, tables, etc. and/or other instructions capable of being executed by processing circuitry 1512 and, utilized by device 1500. Device readable medium may be used to store any calculations made by processing circuitry 1512 and/or any data received via interface 1504. In some embodiments, processing circuitry 1512 and device readable medium 1515 may be considered to be integrated.

The communications interface 1504 is used in the wired or wireless communication of signaling and/or data between device 1500 and other nodes. Interface 1504 may comprise port(s)/terminal(s) to send and receive data, for example to and from device 1500 over a wired connection. Interface 1504 also includes radio front end circuitry that may be coupled to, or in certain embodiments a part of, an antenna. Radio front end circuitry may comprise filters and amplifiers. Radio front end circuitry may be connected to the antenna and/or processing circuitry 1512.

Examples of a device 1500 include, but are not limited to an gNB, a gateway, a smart phone, a mobile phone, a cell phone, a voice over IP (VOIP) phone, a wireless local loop phone, a tablet computer, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc.

The communication interface 1504 may encompass wired and/or wireless networks such as a local-area network (LAN), a wide-area network (WAN), a computer network, a wireless network, a telecommunications network, another like network or any combination thereof. The communication interface may be configured to include a receiver and a transmitter interface used to communicate with one or more other devices over a communication network according to one or more communication protocols, such as Ethernet, TCP/IP, SONET, ATM, optical, electrical, and the like). The transmitter and receiver interface may share circuit components, software, or firmware, or alternatively may be implemented separately.

In one embodiment, a first device is provided and is configured to decode one or more two-dimensional codes by performing the method steps described in relation to FIG. 9. The first device may comprise all, or a selection of the features described in relation to FIG. 15. In one example, this may be a smartphone provided with a camera and appropriate software.

In one embodiment, a second device is provided and further comprises or is communicatively coupled to a printing unit (not shown) comprising a plurality of printing arrangements, where the printing unit is communicatively coupled the processing circuitry 1512. The second device is configured to print one or more two-dimensional codes onto a surface by performing the method steps described in relation to FIG. 14.

In one embodiment, the printing arrangements are arranged at positions corresponding to the plurality of positions 110 of the code. In other words, the printing arrangements are arranged at a plurality of positions. Where the positions of the printing arrangements are arranged along a plurality of concentric circles 120 corresponding to the plurality of concentric circles 120 of the code. The plurality of concentric circles having a common center and being arranged substantially on a two-dimensional plane.

The second device may comprise all, or a selection of the features described in relation to FIG. 15.

FIG. 16 illustrates a use case embodiment of a method according to one or more embodiments in the present disclosure. In this embodiment the method is in this example described as comprising six steps. However, it is understood that method steps indicated as “optional” may be left out or included depending on the application.

The symbols are described below as being dots/circular shapes but may equally be configured with any suitable shape.

For the method steps below, an image is initially obtained and is comprising or depicting one or more two-dimensional code. The image is for example, captured by a scan/photo entity or camera. The scan/photo entity or camera may be arranged internally in the device or arranged externally and communicatively coupled to the device.

In a first optional Step 1610. Image enhancement may be performed, this may e.g., comprise performing contrast and/or brightness adjustment.

The obtained image may be processed to make the symbols appear more prominent to the rest of the image/the background of the image. For the optional image enhancement step 1610, and the following optional symbol size and/or angle correction step 1620. The contrast of the obtained image can be improved based on different methods. For example, the use of fluorescence paint allows you to improve contrast using the color difference, as the likelihood of the same fluorescence color in the rest of the picture is low.

In a second optional Step 1620 symbol size and/or angle correction (i.e., scale capture) may be performed.

In practice the image is likely not taken at an exactly 90° or along a normal to the surface. The circular shapes of the symbols may then appear more like an oval shape, as further illustrated in FIG. 7. This distortion or unwanted effect also puts a limitation on the viewing angle of a scan/photo entity or camera of the surface. Inside a 90°±30° viewing angle, proper detection of any two-dimensional codes is still possible. In this step, the image is scaled in X and Y direction so that a detected inner most circle 0 fits the size of a circle 0 of a mask. A mask is typically a raster with the same (pixel) size as the obtained image. The pixels are considered within detection areas, and not considered outside of detection areas, e.g., when evaluating pixels for presence of symbols.

As described previously, the circles are indexed or numbered from 0 being the inner most circle to a number n being the outer most circle. Furthermore, geometric corrections can also be applied to the obtained image. This will compensate for the viewing angle of the overall captured image as well as geometric distortion caused by a camera lens. Any suitable method for performing geometric corrections known in the art may be used.

The symbols captured in the obtained image can appear larger or smaller depending on the camera's distance to the surface and the focus of the camera. A scanning may be performed as an area-based scanning over the captured image.

In one example, where a maximum number of circles is n. A maximum number of dots N on the diameter of a circle may then be determined using the relation N=2 M+Z−1, where the inner circle radius being Z times the symbol/dot radius. For the assumed values Z=3 and M=6, the two-dimensional code on a particular circle would have a maximum 14 symbols.

Using an assumed capture size of V pixels high, the vertical scanning of a detection area is performed with for example, a square area of V/14 pixels. When the first area (comprising symbols) is detected, the size of the detection area is adjusted to approximately two times the average size of the detected dots/symbols. With this adjusted size of the square detection area, the complete capture is scanned for dots/symbols.

Once the average size of the detect symbol/s is determined the angle correction can be done. A more precise scanning of the symbols/two-dimensional code does not only provide a graphic center of a symbol but also provides the height H and width W of the symbol, as well as the maximum diameter Dmax. These parameters describe angle distortion that would change a circular symbol into an oval, as further illustrated in relation to FIG. 7. Further, focus distortion of the image would make circular symbols look smaller at one or more edges of the captured image compared to symbol in a middle of the captured image.

In one example, for each symbol the following data is extracted:
a graphical center or center of mass of the dot (x, y),
the maximum diameter Dmax,
a minimum diameter Dmin,
a height H of the symbol in the image,
a width W of the symbol in the image,
an angle α between a horizontal axis of the field of view of the image and an axis intersecting the oval along the maximum diameter of the oval Dmax.

In an additional third step 1630 the common center of the plurality of concentric circles is identified. I.e., finding x, y center position/s of the two-dimensional code/s. In other words, the common center is identified using an inner most circle where all symbols are present. If the optional step above has been performed, an average symbol size is thereby known. Therefore, if the average symbol size is known then a scanning mask size or detection areas can be set.

This inner most circle 0 has all symbols present, so a circular circle is formed around the center circle/common center 130. In this embodiment, the area encircled by the inner most circle 0 and respective symbols comprises no symbols. In other words, the inner most circle of the plurality of concentric circles encircles a blank space in the center of the plurality of concentric circles.

This step comprises detecting the inner circle of the two-dimensional code. For this purpose, the blank area is used, and the blank area typically have a diameter of 2 times the symbol diameter. The inner most circle 0 is detected when the outer band of ½ a symbol diameter of the area is in general present, i.e., has a symbol present and the inner 2 dot radius circle is in general blank, i.e., non-present.

If there are more than one two-dimensional code in the captured image, an output of step 3 may be for example, a list of the parameters described in relation to FIG. 7. The parameters include X-Y positions indicating a center for each of the detected circle 0. In other words, each of the X-Y positions represent a center for a two-dimensional code found in the captured image.

In the case of multiple two-dimensional codes are captured in the image, The following steps are performed individually for each captured two-dimensional code.

Detection of the common center 130 is further described in relation to FIG. 2.

In an optional fourth step 1640 a rotational reference is identified.

In this embodiment, this is performed in two steps, step A and step B.

Step—A: Once the common center 130 has been identified, the process continues per found two-dimensional code. In a first optional step a projection error correction is performed, now only for the dots belonging to one of the captured two-dimensional codes. This is similar to what is described in relation to step 1620 above. The reason is that the captured surface in the image, e.g., the cut end of the tree, has a slight angle in view of the image plane where the capture is made. The previous correction in step 1620 was to compensate for distortions caused by the viewing angle of the camera or distortions caused by the camera. This step relates to compensate for the surface on which the two-dimensional code is printed. After this correction step, the dots should be equal in size. Now the detection of the two-dimensional code can start.

Step—B: In this fourth step 1640, rotational reference is identified. The rotational reference may in some embodiments, described further in relation to FIG. 3A-C, involving a line or radius line. The symbols arranged on this start line are always present for all circles of the plurality of circles and produce a straight line from the X-Y center position/common center 130 outward to the outermost circle. The configuration of positions of the remaining symbols is arranged to ensure that they will not produce a straight line from the common center 130. In other words, false detection of start lines is avoided by careful positioning of remaining positions in the two-dimensional code.

Once the rotational reference is identified, the image is rotated so that the start line points exactly north/has a vertical orientation in the obtained image.

There are several embodiments of the rotational reference.

Embodiment A) One option is to use a start radius on which all dots are present exactly on the radius as part of the two-dimensional code key dots. This is further described in relation to FIG. 3A-C. In an optional aspect of embodiment A) two more dots are used, intersecting the central blank space aligning on the radius as part of the two-dimensional code key dots.

Embodiment B) Another option is to use a start sequence on each circle. This is further described in relation to FIG. 4.

Embodiment C) A further alternative is to use a start sequence on the most outer circle only. This is further described in relation to FIG. 5.

In an optional fifth step 1650 a size of the two-dimensional code is identified, e.g., how many circles are used in the two-dimensional code.

In one embodiment, the number of circles used in the two-dimensional code is derived from the second reference pattern portion being indicative of a rotational reference.

In the example illustrated in FIG. 3A-B, the number of symbols, e.g., dots, which are detected along the line 142A or rotational reference 142 determine how many circles are used in the two-dimensional code. Circles shall be present from the inner most circle 0 outward. Circles not used have no start dot present on the line or radius line. The consecutive symbols starting from the inner most circle 0 outward and arranged on the start line, indicate if circles in the code are used. In particular symbols present on the start line indicate that the respective circle is used, and no symbol is present on the start line indicates that the respective circle, and any circle outside of that circle is not used in the two-dimensional code. A minimum of 2 circles are used in the two-dimensional code to ensure an acceptable accuracy for detecting the start line. As can be noted, more concentric circles used in the two-dimensional code, typically leads to better accuracy for detection of the start line. For example, 3 or 4 lines would provide an improved accuracy.

In an optional sixth step 1660 the two-dimensional code is decoded. This may involve applying a mask to the obtained image.

In this step a mask is overlayed onto the image, e.g., providing circular holes in which symbols such in the form of dots can be detected. A dot may e.g., be detected in such a hole (detection area) if a minimum number of pixels exceed a minimum brightness.

All dots of circle 0 should be detected, or else the decoded outcome should optionally be marked with a low trust or reliability rating.

The dots in the other circles R1-Rn are only detected if there is a symbol present on the circle and on the start line 142 or radius/rotational reference 142. This allows for a flexible number of circles in the two-dimensional code to be used. In one embodiment, step 1640 decoding the two-dimensional code comprises generating an output comprises generating bit sequences per circle based on presence or absence of symbols, and a trust or reliability rating.

There are several possibilities for detecting the two-dimensional code. Embodiments are described in relation to FIGS. 10A-B, 11A-B, 12 and 13A-B.

Finally, it should be understood that the invention is not limited to the embodiments described above, but also relates to and incorporates all embodiments within the scope of the appended independent claims.

1-27. (canceled)

28. A method to decode a two-dimensional code, the two-dimensional code comprising:
a plurality of positions, the positions represented by identical geometric shapes arranged adjacently on a plurality of concentric circles, the plurality of concentric circles having a common center and being arranged substantially on a two-dimensional plane, each of said positions indicating presence of a symbol or absence of a symbol, each presence or absence of a symbol at each position being optically readable and representing a data value set to each of the plurality of positions; and
a first reference pattern portion including a set of the plurality of positions indicating at least the common center, wherein the first reference pattern portion comprises all positions along an inner most circle of the plurality of concentric circles, wherein all positions along the inner most circle indicate presence of a symbol; and
wherein the method comprises:
obtaining an image depicting a scene comprising the two-dimensional code;
identifying a common center of a plurality of concentric circles;
identify a rotation of the two-dimensional code;
identify a presence of a symbol or an absence of a symbol for each of a plurality of positions of the two-dimensional code using the identified respective common center and identified rotation; and
decoding the two-dimensional code by mapping the presence of a symbol or an absence of a symbol for each of the plurality of positions to a data value, the data value set to each of the plurality of positions.

29. The method according to claim 28, wherein the symbol is configured with a shape of a dot, wherein identifying a common center comprising identifying a circular shaped area, wherein the circular shaped area is configured with a diameter of 3 times a diameter of the dot shape.

30. The method according to claim 28, wherein decoding the two-dimensional code further comprises applying a mask to the obtained image.

31. The method according to claim 30, wherein the two-dimensional code comprises a second reference pattern portion indicative of a rotational reference of the plurality of positions around the common center, the method further comprising generating the mask by detecting a radial ring line using the symbols, wherein the radial ring line is formed by connecting detected centers of the symbols.

32. The method according to claim 30, further comprising generating the mask by forming a circular area defined by an inner and an outer radius, wherein the mask is generated as a radial segment of the circular area, wherein the mask is applied to the obtained image by rotating the radial segment around the common center.

33. The method according to claim 30, further comprising generating the mask by generating one detection area for each of the plurality of concentric circles, wherein the detection areas are positioned on each of the concentric circles and arranged along a line intersecting the common center, wherein the mask is applied to the obtained image by rotating a radial segment around the common center.

34. The method according to claim 28, further comprising generating an enhanced image by performing image processing on the obtained image.

35. The method according to claim 34, wherein the image processing comprises contrast/brightness adjustment.

36. The method according to claim 34, wherein the image processing comprises symbol size correction.

37. The method according to claim 34, wherein the image processing comprises angle and/or projection correction.

38. The method according to claim 28, wherein identifying the common center comprises:
selecting at least two pairs of symbols, each pair comprising two positions where presence of a symbol has been identified and are on the same concentric circle; and
identifying the common center of the plurality of concentric circles by detecting a position where a respective perpendicular bisector line of the at least two pairs intersect.

39. The method according to claim 28, wherein a subset of the plurality of positions are indicative of a rotational reference of the plurality of positions around the common center, wherein identify a rotational reference comprises detecting the position of the rotational reference of the one or more two-dimensional codes.

40. The method according to claim 39, wherein the rotational reference is one or more reference positions arranged on at least one circle of the plurality of concentric circles.

41. The method according to claim 40, wherein the one or more reference positions are arranged on at least two of the plurality of concentric circles along a line intersecting the common center.

42. The method according to claim 39, wherein the rotational reference is one or more reference positions arranged on at least one circle of the plurality of concentric circles, wherein the one or more reference positions are indicative of a predefined sequence of presence of a symbol or an absence of a symbol.

43. A device comprising:
processing circuitry; and
a memory, said memory containing instructions executable by said processing circuitry, whereby said device is operative to decode a two-dimensional code comprising a plurality of positions, the positions represented by identical geometric shapes arranged adjacently on a plurality of concentric circles, the plurality of concentric circles having a common center and being arranged substantially on a two-dimensional plane, each of said positions indicating presence of a symbol or absence of a symbol, each presence or absence of a symbol at each position being optically readable and representing a data value set to each of the plurality of positions, the two-dimensional code further comprising a first reference pattern portion including a set of the plurality of positions indicating at least the common center, wherein the first reference pattern portion comprises all positions along an inner most circle of the plurality of concentric circles, wherein all positions along the inner most circle indicate presence of a symbol; and
wherein the processing circuitry performs the decoding of the two-dimensional code based on being configured to:
obtain an image depicting a scene comprising the two-dimensional code;
identify a common center of a plurality of concentric circles;
identify a rotation of the two-dimensional code;
identify a presence of a symbol or an absence of a symbol for each of a plurality of positions of the two-dimensional code using the identified respective common center and identified rotation; and
decode the two-dimensional code by mapping the presence of a symbol or an absence of a symbol for each of the plurality of positions to a data value, the data value set to each of the plurality of positions.

44. A method to generate a two-dimensional codes, the two-dimensional code comprising:
a plurality of positions, the positions represented by identical geometric shapes arranged adjacently on a plurality of concentric circles, the plurality of concentric circles having a common center and being arranged substantially on a two-dimensional plane, each of said positions indicating presence of a symbol or absence of a symbol, each presence or absence of a symbol at each position being optically readable and representing a data value set to each of the plurality of positions; and
a first reference pattern portion including a set of the plurality of positions indicating at least the common center, wherein the first reference pattern portion comprises all positions along an inner most circle of the plurality of concentric circles, wherein all positions along the inner most circle indicate presence of a symbol,
the method comprising:
obtaining payload data;
mapping the payload data to a presence of a symbol or an absence of a symbol for each of the plurality of positions of the one or more two-dimensional codes using the identified common center and identified rotation; and
generating the one or more two-dimensional codes by generating the symbols mapped as presence of a symbol on a surface.
